(19) United States
(12) Patent Application Publication
(10) Pub. No.: US 2026/0192371 A1
(43) Pub. Date: Jul. 9, 2026

(54) Autonomous or Manual Working Device and Method for at least Partially Automatically Operating an Object

(71) Applicant: Robert Bosch GmbH, Stuttgart (DE)

(72) Inventors: Andre Heiser, Plochingen (DE); Quang Huy Nguyen, Stuttgart (DE); Stefan Benz, Kirchentellinsfurt (DE); Volker Henrichs, Ludwigsburg (DE); Michael Erz, Muehlacker (DE)

(21) Appl. No.: 19/130,764

(22) PCT Filed: Oct. 16, 2023
(86) PCT No.: PCT/EP2023/078635

§ 371 Date: May 16, 2025

(30) Foreign Application Priority Data
Nov. 18, 2022 (DE) 10 2022 212 301.8

(51) Int. Cl. B23B 49/00; B25J 13/08

(52) U.S. Cl. CPC B23B 49/00; B25J 13/089; B23B 2270/48

(57) ABSTRACT

An autonomous or manual work device, in particular a robot, having a machining unit, in particular a drilling unit, having a locomotion unit for moving the machining unit, and having a control unit at least for controlling the machining unit. The work device includes an inclinometer and a distance measuring instrument arranged on the machining unit. The control unit is designed so as to determine a position and an orientation of at least a part of the machining unit in a work environment model as a function of measured variables determined by way of the inclinometer and the distance measuring instrument.

### PRIOR ART

An autonomous or manual work device with a machining unit, having a locomotion unit for moving the machining unit and with a control unit at least for controlling the machining unit has already been proposed.

### DISCLOSURE OF THE INVENTION

The invention relates to an autonomous or manual work device, in particular a robot, with a machining unit, in particular a drilling unit, with a locomotion unit for moving the machining unit and with a control unit at least for controlling the machining unit.

It is proposed that the work device comprises an inclinometer and a distance measuring instrument arranged on the machining unit, wherein the control unit is designed so as to determine a position and an orientation of at least a part of the machining unit in a work environment model as a function of measured variables determined by means of the inclinometer and the distance measuring instrument.

This type of work device design allows the machining unit to be localized with particular precision. Advantageously, it may be achieved that a position and an orientation in a work environment of the machining unit may be determined precisely and/or reliably. A particularly precise autonomous machining of an object may be realized. Advantageously, collisions between the machining unit and objects in the work environment of the machining unit may be counteracted particularly reliably.

Preferably, the work device is designed as a machining robot, in particular a worksite robot. More preferably, the work device is designed as a drilling robot. Alternatively, however, it is also contemplated that the work device may be designed as a worksite robot other than a drilling robot, for example, as a painting robot, as a window cleaning robot, as a sweeping robot, as an outdoor robot, for example, as a mulching robot, as a hedge-cutting robot, as a snow-clearing robot, as a collecting robot, in particular for collecting leaves, branches or the like, as a combination thereof or as another work device which appears to a person skilled in the art to be useful. In particular, the work device is designed different from a stationary work device. Preferably, the work device may be designed different from an autonomous device fixed at a position, in particular different from an industrial robot. In particular, the work device is designed to move autonomously. “Configured” is understood in particular as meaning specifically programmed, specifically designed, and/or specifically equipped. In particular, the fact that an object is configured for a specific function should be understood to mean that the object fulfills and/or executes this specific function in at least one application state and/or operating state. Preferably, the work device is designed as a mobile work device. Preferably, the work device is designed to be moveable. Alternatively, however, it is also contemplated that the work device may be designed as a drone.

Preferably, the work device is provided for at least partially automatic machining of the object. In particular, the work device is provided for at least partially automatic production of drill holes in the object. Preferably, the work device is provided for autonomous machining of the object, in particular for autonomous production of drill holes in the object. The term “provided” should be understood to mean specifically configured, specifically designed, and/or specifically equipped. An object being “provided” for a specific function is understood to mean that the object fulfills and/or performs this specific function in at least one application and/or operating state. Preferably, the object is a part of a building, for example, a wall, a ceiling, a floor, a facade or the like. Alternatively, however, it is also contemplated that the object may be different from a building part, for example, a fixed, preferably stationary, piece of furniture or the like.

The machining unit preferably comprises a manipulator unit, in particular a robotic arm. In particular, the machining unit has a tool unit, particularly an end-effector. Preferably, the tool unit is arranged on the manipulator unit, preferably on a free end of the manipulator unit. Preferably, the tool unit has a tool receptacle for receiving a tool, a hand-held power tool or the like. More preferably, the tool is designed as a drill. Alternatively, however, it is also contemplated that the tool may be designed as a brush, a squeegee, a grinding wheel, a saw blade, a hammer or any other tool that would appear useful to a person skilled in the art. It is contemplated that the tool and/or the hand-held power tool may be part of the tool unit. It is also contemplated that the tool unit, in particular the tool and/or the tool unit, may be controllable by the control unit. Preferably, the hand-held power tool is designed as a drilling machine. The hand-held power tool may be designed as a commercially available hand-held power tool. The hand-held power tool may be designed as a battery-powered hand-held power tool or as a corded hand-held power tool. Alternatively, it is also contemplated that the hand-held power tool may be specifically designed to cooperate with the machining unit. Alternatively, it is also contemplated that the hand-held power tool may be designed as a screwing machine, a jigsaw, a circular saw, a demolition hammer, a nail gun, a grinding machine or any other hand-held power tool that would appear useful to a person skilled in the art. Preferably, the manipulator unit may have six degrees of freedom. Alternatively, however, it is also contemplated that the manipulator unit may have fewer than six degrees of freedom. Preferably, the manipulator unit is controllable via the control unit. Preferably, the control unit is provided so as to control the machining unit, in particular the manipulator unit and/or the tool unit, preferably the tool and/or the hand-held power tool, when machining the object.

Preferably, the locomotion unit is provided so as to generate a locomotion force. Preferably, the machining unit, in particular the manipulator unit, is arranged at, preferably on, the locomotion unit. Preferably, the tool unit is at least mechanically connected to the locomotion unit via the manipulator unit. In particular, the locomotion unit is provided so as to move the machining unit on a subsurface, for example, a floor, a wall and/or a ceiling. Preferably, the locomotion unit is provided for moving the work device as a whole over the subsurface. In particular, the locomotion unit may have a chassis. For example, the locomotion unit, in particular the chassis, may have a chain unit, a roller unit, a wheel unit, a propeller unit or other locomotion means that would appear to be useful to a person skilled in the art, or a combination thereof.

In particular, the chain unit has at least one chain drive, preferably at least two chain drives. For example, the wheel unit comprises at least one wheel, preferably at least two wheels, preferably at least three wheels and more preferably at least four wheels. For example, the roller unit comprises, at least one roller, preferably at least two rollers, preferably at least three rollers and more preferably at least four rollers. In particular in the case of a work device designed as a drone, the locomotion unit comprises at least one propeller unit or the like for locomotion. For example, the propeller unit has at least one propeller, preferably at least two propellers and more preferably at least four propellers.

Preferably, the locomotion unit has at least one drive unit. In particular, the drive unit is provided so as to drive the chassis, preferably the wheel unit, the roller unit, the chain unit, the propeller unit or the like. In particular, the drive unit comprises at least one electric motor or the like. A movement of a device frame of the work device, in particular of the locomotion unit, is coupled to a drive, in particular a movement, of the chassis. Through the chassis, which may preferably be driven by the drive unit, a movement of the device frame relative to the subsurface, in particular relative to the work environment, is producible in particular.

In particular, the movement of the device frame relative to the subsurface is dependent on a control by the control unit. The drive unit is provided so as to drive the chassis to a translatory and/or rotational movement of the device frame, in particular as a function of an actuation by the control unit. In particular, the control unit comprises at least one processor and one memory element, as well as an operating program stored on the memory element. The memory element is preferably designed as a digital storage medium, e.g., a hard disk or the like.

For example, the work environment may be an interior area of a building, an exterior area, in particular of a building, or the like. In particular, the machining unit is provided so as to machine at least the object according to a machining plan. For example, the machining plan is registered in a work environment model of the work environment. Preferably, the work environment model may be a building information modeling (BIM) model or the like. The machining plan is stored on the memory element of the control unit, for example. Preferably, the work environment model may be stored on the memory element of the control unit. In particular, the control unit may be provided so as to navigate the locomotion unit and/or the machining unit in the work environment, at least on the basis of the machining plan and/or the work environment model of the work surroundings. Alternatively, it is also contemplated that the work environment model may be stored on an external unit, wherein the external unit may preferably be connectable to the autonomous work device for data purposes, in particular cordlessly and/or corded. For example, the external unit may be designed as a smartphone, a cloud, a central computer, a server, a laptop, a smart home system or the like. It is also contemplated that the external unit may feature at least part of the control unit.

The work tool preferably comprises at least one detection unit, in particular one that is different from the distance measuring instrument and the inclinometer. Alternatively, it is contemplated that the inclinometer and/or the distance measuring instrument are part of the detection unit. The control unit is preferably provided so as to control the work device, in particular the locomotion unit and/or the machining unit, as a function of information acquired by means of the detection unit. The detection unit is preferably at least partially designed as an optical detection unit. The detection unit comprises, for example, at least one lidar unit for detecting a work environment. Alternatively or additionally, it is also contemplated that the detection unit may have a stereo camera, a time-of-flight camera, a camera system based on fringe projection and/or other detection means that would appear useful to a person skilled in the art. The control unit is preferably provided so as to evaluate the information recorded by the detection unit, in particular the lidar unit, based on a simultaneous localization and mapping (SLAM) method. In particular, the simultaneous localization and mapping (SLAM) method is a method for simultaneous position determination and map generation in robotics, wherein, in particular within the method, preferably simultaneously, a virtual map of an environment and a spatial position of a movable unit, in particular the work device, is determined within the virtual map. The control unit is provided in particular so as to control the locomotion unit during a movement in the work environment as a function of information acquired by means of the detection unit, preferably the lidar unit. Alternatively or additionally, it is contemplated that the control unit is provided so as to control the locomotion unit as it moves in the work environment as a function of measured variables determined by means of the inclinometer and/or the distance measuring instrument.

In particular, the inclinometer is provided so as to determine an inclination relative to an installation plane of the work device, in particular the locomotion unit. The inclinometer may be designed as a mechanical inclinometer, an electrical inclinometer or a digital inclinometer. The distance measuring instrument is preferably designed as an electro-optical distance measuring instrument, in particular as a laser interferometer. Alternatively, it is also contemplated that the distance measuring instrument may be designed as an optical distance measuring instrument. The distance measuring instrument is preferably provided so as to determine the distance to objects in the work environment. The determining of a position and an alignment of at least the part of the machining unit preferably comprise a determination of a position and all rotational positions of the part of the machining unit. Preferably, the part of the machining unit corresponds here to a tool unit of the machining unit, in particular a tool, for example, a tool arranged on a hand-held power tool, of the tool unit.

It is further proposed that the control unit be provided so as to use at least one measured variable of the inclinometer to align the distance measuring instrument. Advantageously, a particularly efficient, precise and/or quick localization of the work device, in particular the machining unit and/or the locomotion unit, may occur. In particular, the control unit may be provided so as to use at least one measured variable of the inclinometer for a vertical alignment of the manipulator unit of the machining unit. Preferably, the control unit may be provided so as to transform a coordinate system of the manipulator unit into a vertical position as a function of an inclination of the manipulator unit relative to the installation plane determined by means of the inclinometer. The control unit is preferably provided so as to control the machining unit and/or the locomotion unit after a transformation of the coordinate system of the manipulator unit into the vertical position for a movement of the machining unit to a machining position of the machining unit. The machining position preferably only contains information on a position of the work device, in particular the machining unit. The machining position is preferably at least free of information on an alignment, in particular on rotational positions, of the machining unit, preferably on the part of the machining unit. The machining position is preferably stored in the machining plan, in particular in the work environment model. Preferably, the autonomous work device, in particular the locomotion unit, may be in a fixed position when measured variables are detected by the inclinometer and/or the distance measuring instrument to determine a position and an orientation of at least the part of the machining unit.

It is further proposed that the distance measuring instrument is provided so as to detect, in a state of the distance measuring instrument aligned by means of the inclinometer, a measured variable in at least two different angular positions for determining the position and the alignment of the part of the machining unit in the work environment model. Advantageously, a measured variable of the work environment can be captured particularly precisely. A particularly precise determination of an orientation and a position of the machining unit, in particular the manipulator unit, in the work environment can occur. Advantageously, a particularly precise machining of the object may be enabled by means of the machining unit. A particularly high quality of work may be achieved. The distance measuring instrument is preferably arranged, in particular in a state aligned by means of the inclinometer, such that a detection direction of the distance measuring instrument in a vertically aligned state of the manipulator unit, in particular by means of the inclinometer, extends in a plane that is at least substantially perpendicular to the axis when the manipulator unit is rotated about an axis. The term “substantially perpendicular” can be understood to mean an alignment of a direction relative to a reference direction, wherein, in particular viewed in a projection plane, the direction and the reference direction enclose an angle of 90° and the angle has a maximum deviation of in particular less than 8°, advantageously less than 5°, and particularly advantageously less than 2°. The control unit is preferably provided so as to control the manipulator unit to rotate about the axis such that the distance measuring instrument detects a measured variable in the at least two different angular positions. The control unit is provided in particular so as to determine an actual position in the work environment of at least one object classified as a localization reference object of the work environment in the work environment model and, in particular, to compare it with a target position from the work environment model. The object classified as a location reference object is preferably a wall in the work environment. Alternatively, the object classified as localization reference object may also be the object to be machined, in particular a ceiling, a floor, a facade, another, preferably stationary, part of a building or stationary, in particular stationary, object in the work environment. It is contemplated that objects may be automatically classified as localization reference object by the work device and/or manually by a user. An object is preferably classified as a localization reference object by means of the control unit, in particular by comparing a nominal characteristic of the object and an actual characteristic of the object. The control unit is provided in particular so as to determine a deviation of the actual characteristic from the nominal characteristic when comparing the nominal characteristic of the object with the actual characteristic of the object. The control unit is preferably provided so as to classify the object as a localization reference object if a value of the deviation of the actual characteristic variable from the nominal characteristic variable is within a tolerance range to a value of the nominal characteristic variable. If a value of the deviation of the actual characteristic from the nominal characteristic is outside the tolerance range for a value of the nominal characteristic, the object is excluded in particular from classification as a localization reference object by the control unit. The tolerance range is preferably defined in the operating program, in particular in the work environment model. It is contemplated that the tolerance range may be adjusted, in particular manually by an operator and/or automatically by the control unit, for example, depending on information stored in the work environment model. It is also contemplated that different tolerance ranges may be assigned to different objects in the work environment in the work environment model. The control unit is provided in particular so as to determine a standard of the localization reference object from the comparison of the actual position with the target position. The control unit is preferably provided so as to use the actual position of the object classified as localization reference object in the work environment and its standard to determine the position and alignment of the part of the machining unit in the work environment model. Preferably, the control unit is provided for converting an entirety of coordinates from the machining plan into the coordinate system of the manipulator unit, in particular into a coordinate system of at least the part of the machining unit, from the determined alignment and position of at least the part of the machining unit. Preferably, the control unit is provided so as to control the machining unit and/or the locomotion unit for machining the object as a function of the determined alignment and position of at least the part of the machining unit.

It is further proposed that the work device may feature a height-adjustable work platform, which may be arranged on the locomotion unit and on which the distance measuring instrument may be arranged. Advantageously, a particularly flexible and at the same time precise machining of the object may be enabled. The distance measuring instrument is preferably arranged on the manipulator unit, in particular on a free end of the manipulator unit. The inclinometer is arranged in particular on the work platform. The inclinometer is preferably arranged on the manipulator unit, in particular arranged at the free end of the manipulator unit. Alternatively, it is also contemplated that the inclinometer may be arranged separate from the manipulator unit on the work platform and/or that the inclinometer is arranged separately from the machining unit, for example in a housing of the work device, in particular the locomotion unit. The manipulator unit may be arranged on the work platform. The work platform may be height-adjustable relative to a subsurface on which the work device, in particular the locomotion unit, may be arranged. In particular, the work device may feature a lifting unit. The work platform may be height-adjustable by means of the lifting unit. By way of example, the lifting unit may feature a telescopic rod. The telescopic rod may be designed as a hydraulic telescopic rod. Alternatively, it is also contemplated that the lifting unit may feature more than one telescopic rod. Furthermore, it is alternatively or additionally contemplated that the lifting unit may feature a scissor lift mechanism, a linear drive, for example a toothed rack, a push chain, a ball screw drive, a linear motor, or the like. The work platform may be connected to the locomotion unit via the lifting unit, in particular the telescopic rod. In particular, the lifting unit may be connected to the control unit for controlling purposes, in particular cordlessly and/or corded. It is contemplated that the lifting unit may be part of the machining unit. Alternatively, it is also contemplated that the work platform may be arranged on the manipulator unit of the machining unit such that the work platform may be height-adjustable by means of the manipulator unit.

Furthermore, the invention is based on a method for at least partially automatic machining of an object, in particular of the aforementioned object, in particular for an at least partially automatic production of drill holes in an object, preferably a part of a building, in particular a part of the building already mentioned above, by means of an autonomous or manual work device, in particular the aforementioned work device. It is proposed that, as a function of measured variables determined by means of an inclinometer of the work device, in particular the aforementioned one, and by means of a distance measuring instrument of the work device, in particular the aforementioned one, a position and an orientation of at least a part, in particular the aforementioned part, of a machining unit, in particular the aforementioned machining unit, of the work device in a work environment model, in particular of the aforementioned one, can be determined. Such a method may enable particularly precise localization of the machining unit in a work environment. Advantageously, it may be achieved that a position and an orientation in the work environment of the machining unit may be determined precisely and/or reliably. A particularly precise autonomous machining of an object may be realized. Advantageously, collisions between the machining unit and objects in the work environment of the machining unit may be counteracted particularly reliably.

Further, it is proposed that the distance measuring instrument is oriented using the inclinometer prior to the detection of a measured variable. Advantageously, a particularly efficient, precise and/or quick localization of the work device, in particular the machining unit and/or the locomotion unit, may occur.

It is further proposed that the distance measuring instrument may detect at least one measured variable in at least two different angular positions in a state when aligned by means of the inclinometer. Advantageously, a measured variable of the work environment can be captured particularly precisely. A particularly precise determination of an orientation and a position of the machining unit, in particular the manipulator unit, in the work environment can occur. Advantageously, a particularly precise machining of the object may be enabled by means of the machining unit. A particularly high quality of work may be achieved.

In addition, it is proposed that the distance measuring instrument is rotated about one axis for a detection of a measured variable in each of the at least two angular positions, in particular about the axis already mentioned above, which runs in the soldering direction. Advantageously, a measured variable of the work environment can be captured particularly precisely. A particularly precise determination of an orientation and a position of the machining unit, in particular the manipulator unit, in the work environment can occur. Advantageously, a particularly precise machining of the object may be enabled by means of the machining unit. A particularly high quality of work may be achieved.

The work device and/or the method should not be limited to the application and embodiment described above in this regard. In particular, the work device and/or the method may have a number of individual elements, components and units as well as method steps that may deviate from a number specified herein in order to fulfill a mode of operation described herein. Additionally, regarding the ranges of values indicated in this disclosure, values lying within the limits specified hereinabove are also provided so as to be considered as disclosed and usable as desired.

### DRAWINGS

Further advantages follow from the description of the drawings below. Five exemplary embodiments of the invention are shown in the drawing. The drawing, the description, and the claims contain numerous features in combination. A person skilled in the art will appropriately also consider the features individually and combine them into additional advantageous combinations.

The figures show:

FIG. 1 a schematic representation of an autonomous work device and an object to be machined,

FIG. 2 the autonomous work device in a work environment in a schematic top view,

FIG. 3 a part of the autonomous work device with an interface device in a schematic view,

FIG. 4 a schematic sequence of a method for at least partially automatic machining of an object,

FIG. 5 a schematic sequence of a further method for at least partially automatic machining of an object,

FIG. 6 a system with an autonomous work device in a first alternative embodiment and with a localization reference element and an object to be machined in a schematic representation,

FIG. 7 a schematic sequence of a method for at least partially automatic machining of the object by means of the autonomous work device from FIG. 6,

FIG. 8 an autonomous work device in a second alternative embodiment and an object to be machined in a schematic representation,

FIG. 9 a schematic sequence of a method for at least partially automatic machining of the object by means of the autonomous work device from FIG. 8,

FIG. 10 a system with an autonomous work device in a third alternative embodiment and with a projection unit and an object to be machined in a schematic representation,

FIG. 11 a schematic sequence of a method for at least partially automatic machining of the object by means of the system shown in FIG. 10,

FIG. 12 a system with an autonomous work device in a fourth alternative embodiment and with at least two localization elements and an object to be machined in a schematic representation, and

FIG. 13 a schematic sequence of a method for at least partially automatic machining of the object by means of the system shown in FIG. 12.

### DESCRIPTION OF THE EXEMPLARY EMBODIMENTS

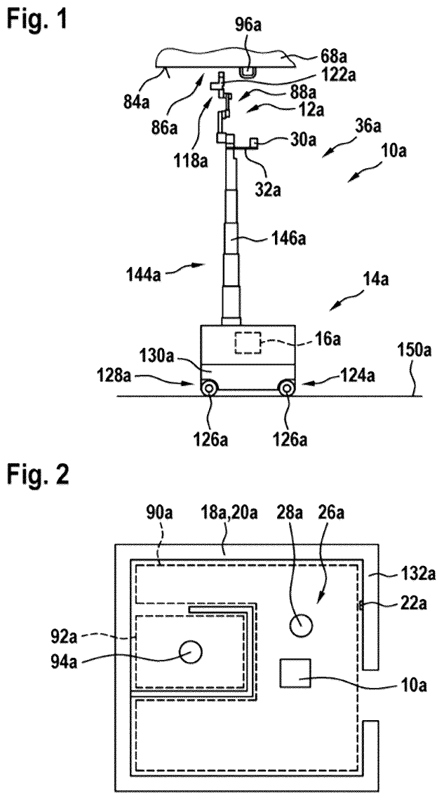

FIG. 1 shows a system 36a with an autonomous work device 10a. Alternatively, it is also contemplated that the work device 10a is designed as a manual work device 10a. The autonomous work device 10a is designed as a worksite robot, in particular as a drilling robot. Alternatively, however, it is also contemplated that the autonomous work device 10a may be designed as a worksite robot other than a drilling robot, for example, as a painting robot, as a window cleaning robot, as a sweeper robot, as an outdoor robot, for example, as a mulching robot, as a hedge-cutting robot, as a snow-clearing robot, as a collecting robot, in particular for collecting leaves, branches or the like, as a combination thereof or as another autonomous work device 10a which appears useful to a person skilled in the art. The autonomous work device 10a is designed different from a stationary autonomous work device. The autonomous work device 10a is designed differently from an autonomous device permanently installed at a position, in particular an industrial robot. The autonomous work device 10a is configured to move autonomously. The autonomous work device 10a is designed as a mobile autonomous work device. The autonomous work device 10a is designed to be moveable. Alternatively, however, it is also contemplated that the autonomous work device 10a may be designed as a drone.

The autonomous work device 10a is provided for at least partially automatic machining of an object 68a. By way of example, the autonomous work device 10a is provided here for at least partially automatic production of drill holes in the object 68e. The autonomous work device 10a is provided for autonomous machining of the object 68a, in particular for autonomous production of drill holes in the object 68a. Object 68a is a part of a building, in particular a ceiling. Alternatively, it is contemplated that the object 68a may be a wall, a floor, a facade, a piece of furniture or the like.

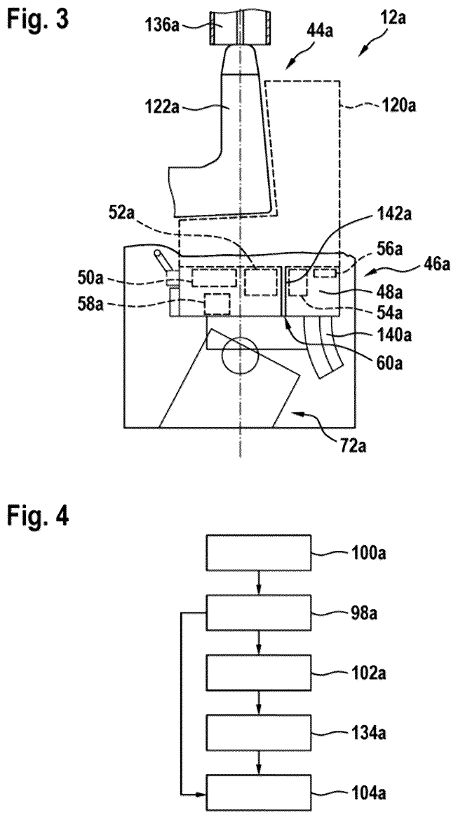

The autonomous work device 10a has a machining unit 12a. The machining unit 12a has a drilling unit 88a, in particular is designed as a drilling unit 88a. The machining unit 12a has a tool unit 44a (see also FIG. 3). The tool unit 44a is designed as an end effector. The tool unit 44a has a tool receptacle 120a for receiving a hand-held power tool 122a. A hand-held power tool 122a is arranged on the tool receptacle 120a. The hand-held power tool 122a is part of the autonomous work device 10a, in particular the tool unit 44a. The tool unit 44a, in particular the hand-held power tool 122a, is controllable by the control unit 16a. The hand-held power tool 122a is designed as a drilling machine. The hand-held power tool 122a may be designed as a commercially available hand-held power tool. The hand-held power tool 122a may be designed as a battery-powered hand-held power tool or as a corded hand-held power tool. Alternatively, it is also contemplated that the hand-held power tool 122a may be specifically designed to interact with the machining unit 12a. Alternatively, it is also contemplated that the hand-held power tool 122a may be designed as a screwing machine, as a jigsaw, as a dowel setter, as a slot cutter, as a cut-off grinder, as a circular saw, as a demolition hammer, as a nail gun, as a grinding machine or as any other hand-held power tool that would appear useful to a person skilled in the art. Alternatively or additionally, it is contemplated that the tool receptacle 120a may be configured to receive a tool or the like. The tool may be designed, for example, as a drill, a brush, a squeegee, a grinding wheel, a saw blade, a hammer or any other tool that would appear useful to a person skilled in the art. It is contemplated that the tool may be part of the tool unit 44a. Furthermore, it is alternatively or additionally contemplated that the tool unit 44a may be designed for a rotary drive, an oscillatory drive or the like of the tool.

For example, the tool receptacle 120a of the tool unit 44a has a two-point attachment in a state of the hand-held power tool 122a attached to the tool receptacle 120a with the hand-held power tool 122a. Alternatively, it is contemplated that the tool holder 120a may have a single-point fastening or at least a three-point fastening when the hand-held power tool 122a is fastened to the tool holder 120a with the hand-held power tool 122a. Preferably, the tool receptacle 120a has a, preferably damped, spring unit (not shown here), via which in particular the hand-held power tool 122a and/or the tool in a state arranged on the tool receptacle 120a is connected to the tool receptacle 120a. It is contemplated that the damping of the spring unit may be adjustable. For example, the spring unit has at least one spring element, in particular a coil spring, a leaf spring, a rubber-elastic element or the like.

The machining unit 12a has a manipulator unit 72a. The manipulator unit 72a is designed as a robot arm. The manipulator unit 72a has multi-axis kinematics. The manipulator unit 72a has six degrees of freedom. Alternatively, however, it is also contemplated that the manipulator unit 72a may have fewer than six degrees of freedom. The manipulator unit 72a is controllable via the control unit 16a. The control unit 16a is provided so as to control the machining unit 12a, in particular the manipulator unit 72a and/or the tool unit 44a, preferably the hand-held power tool 122a, when machining the object 68a.

The autonomous work device 10a has a locomotion unit 14a for moving the machining unit 12a. The locomotion unit 14a is provided so as to generate a locomotion force. The machining unit 12a, in particular the manipulator unit 72a, is arranged at, preferably on, the locomotion unit 14a. The tool unit 44a is at least mechanically connected to the locomotion unit 14a via the manipulator unit 72a. The locomotion unit 14a is provided so as to move the machining unit 12a on a subsurface 150a, for example, a floor, a wall and/or a ceiling. The locomotion unit 12a is provided so as to move the autonomous work device 10a as a whole over the subsurface 150a. The locomotion unit 14a has a chassis 128a. The locomotion unit 14a, in particular the chassis 128a, has a wheel unit 124a. The wheel unit 124a comprises four wheels 126a (only two of the four wheels 126a are shown in FIG. 1). Alternatively, it is also contemplated that the wheel unit 124a may have only one wheel, two wheels, three wheels or more than four wheels. Alternatively or additionally, it is contemplated that the locomotion unit 14a may have a chain unit, a roller unit, a propeller unit or other locomotion means that would appear useful to a person skilled in the art, or a combination thereof. In particular, the chain unit has at least one chain drive, preferably at least two chain drives. For example, the roller unit comprises, at least one roller, preferably at least two rollers, preferably at least three rollers and more preferably at least four rollers. In particular in the case of an autonomous work device 10a designed as a drone, the locomotion unit 14a comprises at least one propeller unit or the like for locomotion. For example, the propeller unit has at least one propeller, preferably at least two propellers and more preferably at least four propellers.

The locomotion unit 14a has at least one drive unit (not shown here). The drive unit is provided so as to drive the chassis 128a, in particular the wheel unit 124a. The drive unit comprises at least one electric motor or the like. A movement of a device frame 130a of the autonomous work device 10a, in particular, of the locomotion unit 14a, is coupled to a drive, in particular a movement, of the chassis 128a. Through the chassis 128a, which is preferably driven by a drive unit, a movement of the device frame 130a is producible.

The autonomous work device 10a has a control unit 16a at least for controlling the machining unit 12a. The movement of the device frame 130a is dependent on an actuation by the control unit 16a. The drive unit is provided so as to drive the chassis 128a to a translatory and/or rotational movement of the device frame 130a, in particular as a function of an actuation by the control unit 16a. In particular, the control unit 16a comprises at least one processor and one memory element as well as an operating program stored on the memory element. The memory element is preferably designed as a digital storage medium, e.g., a hard disk or the like. The machining unit 12a, in particular the tool unit 44a and/or the manipulator unit 72a, is controllable by means of the control unit 16a.

The autonomous work device 10a has a height-adjustable work platform 32a. Alternatively, it is also contemplated that the autonomous work device 10a may be designed free of a height-adjustable work platform 32a. The work platform 32a is arranged on the locomotion unit 14a. The manipulator unit 72a is arranged on the work platform 32a. The work platform 32a is height-adjustable relative to a subsurface 150a on which the autonomous work device 10a, in particular the locomotion unit 14a, is arranged. The autonomous work device 10a has a lifting unit 144a. The work platform 32a is height-adjustable by means of the lifting unit 144a. The lifting unit 144a has a telescopic rod 146a. The telescopic rod 146a is designed as a hydraulic telescopic rod. Alternatively, it is also contemplated that the lifting unit 144a may have more than one telescopic rod 146a. Furthermore, it is alternatively or additionally contemplated that the lifting unit 144a may have a scissor lift mechanism, a linear drive, for example, a toothed rack, a push chain, a ball screw drive, a linear motor, or the like. The work platform 32a is connected to the locomotion unit 14a via the lifting unit 144a, in particular the telescopic rod 146a. The lifting unit 144a is connected to the control unit 16a for controlling purposes, in particular cordlessly and/or corded. The lifting unit 144a is part of the machining unit 12a. For example, it is alternatively contemplated that the work platform 32a may be arranged on the manipulator unit 72a of the machining unit 12a, such that the work platform 32a is height-adjustable by means of the manipulator unit 72a.

The control unit 16a is provided so as to classify the test object 18a as a localization reference object 20a at least as a function of a comparison of a nominal characteristic variable of at least one test object 18a in a work environment 26a of the machining unit 12a and an actual characteristic variable of the at least one test object 18a. The work environment 26a here is, for example, an interior area of a building. Alternatively, it is also contemplated that the work environment may be an outdoor area, in particular of a building, or the like. The test object 18a is a wall in the work environment 26a of the machining unit 12a. Alternatively, the test object 18a may also be the object 68a, in particular a ceiling, a floor, another, preferably fixed, building part or fixed, in particular stationary, object in the work environment 26a.

The nominal characteristic of the test object 18a has at least information about a target position of the test object 18a. Alternatively or additionally, it is contemplated that the nominal characteristic of the test object 18a may have information on at least one dimension, in particular a height and/or a width, of the test object 18a, a material characteristic of the test object 18a, a surface characteristic, for example, a flatness, of the test object 18a, a temperature characteristic of the test object 18a, a humidity characteristic of the test object, a combination thereof or the like. The nominal characteristic is stored on the memory element of the control unit 14a, in particular in a work environment model of the work environment 26a. The work environment model is a building information modeling (BIM) model or the like. It is stored in the work environment model which objects in the work environment 26a are to be understood as test objects 18a. The work environment model is stored on the memory element of the control unit 16a. Alternatively, it is also contemplated that the work environment model may be stored on an external unit (not shown here), wherein the external unit may preferably be connectable to the autonomous work device 10a for data purposes, in particular cordlessly and/or corded. For example, the external unit may be designed as a smartphone, a cloud, a central computer, a server, a laptop, a smart home system or the like. It is also contemplated that the external unit may have at least part of the control unit 16a. The machining unit 12a is provided so as to machine at least the object 68a according to a machining plan. The machining plan is stored, for example, on the memory element of the control unit 16a. The machining plan is registered in the work environment model, for example. The control unit 16a is provided so as to navigate the locomotion unit 14a and/or the machining unit 12a in the work environment 26a, at least on the basis of the machining plan and/or the work environment model.

The autonomous work device 10a has at least one detection unit 30a. The detection unit 30a is arranged on the work platform 32a. Alternatively, it is also contemplated that the detection unit 30a may be arranged on the machining unit 12a or on the locomotion unit 14a. The detection unit 30a is provided for detecting the actual characteristic of the test object 18a. The control unit 16a is provided so as to control the autonomous work device 10a, in particular the locomotion unit 14a and/or the machining unit 12a, as a function of information acquired by means of the detection unit 30a, preferably when localized in the work environment 26a, in particular when localized in the work environment 26a on the basis of the machining plan and/or the work environment model. The detection unit 30a is designed as an optical detection unit. The detection unit 30a has at least one lidar unit (not shown here) for detecting the work environment 26a. Alternatively or additionally, it is contemplated that the detection unit 30a may have a stereo camera, a time-of-flight camera, a camera system based on fringe projection and/or other detection means that would appear useful to a person skilled in the art. The detection unit 30a is configured to detect the actual characteristic of the test object 18a or information for determining the actual characteristic of the test object 18a. The control unit 16a is provided so as to evaluate the information recorded by the detection unit 30a, in particular the lidar unit, based on a simultaneous localization and mapping (SLAM) method. In particular, the simultaneous localization and mapping (SLAM) method is a method for simultaneous position determination and map generation in robotics, wherein, in particular within the method, preferably simultaneously, a virtual map of an environment and a spatial position of a movable unit, in particular the autonomous work device, is determined within the virtual map.

The control unit 14a is provided so as to control the machining unit 12a as a function of the at least one test object 18a classified as localization reference object 20a. The control unit 16a is provided so as to control the locomotion unit 14a as a function of the test object 18a classified as localization reference object 20a. The control unit 16a is provided so as to control the machining unit 12a, in particular the manipulator unit 72a and/or the tool unit 44a, and/or the locomotion unit 14a as a function of the test object 18a classified as localization reference object 20a. The control unit 16a is provided so as to control the machining unit 12a and/or the locomotion unit 14a as a function of the test object 18a classified as localization reference object 20a for localization, in particular during a movement of the machining unit 12a and/or the locomotion unit 14a in the work environment 26a. The control unit 16a is provided so as to control the machining unit 12a and/or the locomotion unit 14a during machining of the object 68a by the machining unit 12a as a function of the test object 18a classified as localization reference object 20a.

The control unit 16a is provided so as to ignore a test object 18a excluded from classification as a localization reference object 20a as a result of the comparison of the actual characteristic of the test object 18a with the nominal characteristic of the test object 18a during a localization, in particular a movement, of the machining unit 12a and/or the locomotion unit 14a. The control unit 16a is provided so as to ignore a test object 18a excluded from classification as a localization reference object 20a as a result of the comparison of the actual characteristic of the test object 18a with the nominal characteristic of the test object 18a when the object 68a is machined by the machining unit 12a.

The control unit 16a is provided so as to determine a deviation of the actual characteristic from the nominal characteristic when the nominal characteristic of the test object 18a is compared with the actual characteristic of the test object 18a. If a value of the deviation of the actual characteristic from the nominal characteristic is within a tolerance range to a value of the nominal characteristic, the control unit 16a classifies the test object 18a as a localization reference object 20a. If a value of the deviation of the actual characteristic from the nominal characteristic is outside the tolerance range for a value of the nominal characteristic, the test object 18a is excluded from classification as a localization reference object 20a by the control unit 16a. In particular, the tolerance range is defined in the operating program, in particular in the work environment model. It is contemplated that the tolerance range may be adjusted, in particular manually by an operator and/or automatically by the control unit 16a, for example, as a function of the information stored in the work environment model.

The control unit 16a is provided so as to identify, at least as a function of a classification of the at least one test object 18a, subareas 90a, 92a of a work environment 26a in which localization of the machining unit 12a is possible on the basis of the at least one test object 18a. If, for example, the at least one test object 18a classified by the control unit 16a as a localization reference object 20a is detectable by the detection unit 30a in one of the subareas 90a, 92a, it may be possible to localize the machining unit 12a in this one of the subareas 90a, 92a using the test object 18a, preferably by means of the control unit 16a. If, for example, another of the subareas 90a, 92a of the work environment is free of test objects 18a which are detectable by the detection unit 30a and classifiable as localization reference objects 20a by the control unit 16a, localization of the machining unit 12a, in particular with sufficient precision, by the control unit 16a in this other of the subareas 90a, 92a on the basis of localization reference objects 20a is not achievable.

FIG. 2 shows an example of a subarea 90a of the work environment 26a, in which the at least one test object 18a classified by the control unit 16a as a localization reference object 20a is detected by the detection unit 30a, such that localization of the machining unit 12a is possible in the subarea 90a based on the at least one test object 18a. A further subarea 92a of the work environment 26a is free of test objects 18a detectable by means of the detection unit 30a and which is classifiable localization reference objects 20a by means of the control unit 16a, such that, in particular, localization of the machining unit 12a in the further subarea 92a based on test objects 18a, in particular based on test objects 18a classified as localization reference objects 20a, by means of the control unit 16a is excluded.

The control unit 16a is provided so as to utilize an support point 28a, 94a assigned to the machining unit 12a in the work environment 26a of the machining unit 12a to check a localization of the machining unit 12a at the support point 28a, 94a required for machining the object 68a. The support points 28a, 94a are stored in the work environment model. The support points 28a, 94a represent positions which enable autonomous localization and/or autonomous operation of the autonomous work device 10a, in particular the machining unit 12a and/or the locomotion unit 14a, in the entire work area 26a, in particular autonomous operation and/or autonomous navigation of the autonomous work device 10a, preferably the machining unit and/or the locomotion unit, for machining the object, preferably for executing the machining plan, if it is possible to localize the autonomous work device 10a, in particular the machining unit 12a and/or the locomotion unit 14a, at the support points 28a, 94a. The control unit 16a is provided so as to check at least at the support points 28a, 94a, in particular on the basis of information of the work environment 26a detected by means of the detection unit 30a, whether a localization of the autonomous work device 10a, in particular of the machining unit 12a and/or the locomotion unit 14a, is possible at the support points 28a, 94a on the basis of the at least one test object 18a which is classified as a localization reference object 20a.

The control unit 16a is provided so as to check a need for additional localization reference elements 22a. The control unit 16a is provided so as to determine a need for additional localization reference objects 22a for subareas of the 90a, 92a work environment 26a in which localization of the machining unit 26a using the at least one test object 18a classifiable as a localization reference object 20a is excluded, in particular a number of additional localization reference elements 22a needed for localizing the machining unit 12a in the subareas 90a, 92a, in which in particular localization of the machining unit 12a using the at least one test object 18a classifiable as a localization reference object 20a is excluded. In particular, the control unit 16a is provided so as to determine a need for additional localization reference elements 22a for interpolation points 28a, 94a of the work environment 26a at which localization of the machining unit 12a using the at least one test object 18a classifiable as a localization reference object 20a is excluded, in particular a number of additional localization reference elements 22a required for localizing the machining unit 12a at the interpolation points 28a, 94a, at which in particular localization of the machining unit 12a by means of the at least one test object 18a classifiable as a localization reference object 20a is excluded.

It is contemplated that the need for additional localization reference elements 22a may comprise only one additional localization reference element 22a, two additional localization reference elements 22a, at least three additional localization reference elements 22a, or a plurality of additional localization reference elements 22a. The need for additional localization reference elements 22a depends on the machining plan. The additional localization reference elements 22a are objects specifically designed for localization. The additional localization elements 22a are designed as reflective markers, in particular as triple mirrors, reflective foils, or the like.

The detection unit 30a is configured to detect the additional localization reference elements 22a. The control unit 16a is provided so as to control the machining unit 12a and/or the locomotion unit 14a for localizing the machining unit 12a and/or the locomotion unit 14a in the work environment 26a and/or for machining the object 68a by the machining unit 12a, in particular as required, depending on additional localization reference elements 22a installed in the work environment 26a.

Subareas 90a, 92a, in particular support points 28a, 94a, of the work environment 26a, in/at which localization of the autonomous work device 10a, preferably the machining unit 12a and/or the locomotion unit 14a, is possible by means of the control unit 16a using the at least one test object 18a classified as a localization reference object 20a, is free of a need for additional localization reference elements 22a.

The control unit 16a is provided so as to determine a target installation position for at least one additional localization reference element 22a depending on a check of the need for additional localization reference elements 22a. For example, the autonomous work device 10a comprises an output unit (not shown here). For example, the output unit is designed as an optical output unit, an acoustic output unit, a haptic output unit or a combination thereof. The output unit may have, for example, a screen, a light element such as an LED or a laser, a loudspeaker or the like. It is contemplated that the output unit may be provided so as to output the target installation position. For example, it is contemplated that the target installation position may be displayed on a screen of the output unit and/or that the output unit is configured for a projection of the target installation position in the work environment 26a. Alternatively or additionally, it is also contemplated that the autonomous work device 10a, in particular the machining unit 12a, may be configured to at least partially automatically attach the additional localization reference element 22a to the target installation position.

The autonomous work device 10a has an interface device 46a. The tool unit 44a is connected to the autonomous work device 10a, in particular the manipulator unit 72a of the machining unit 12a, by means of the interface device 46a. The interface device 46a has a robot-tool connection unit 48a at least for a mechanical connection of the tool unit 44a to the autonomous work device 10a, in particular the manipulator unit 72a. The robot-tool connection unit 48a is arranged on the manipulator unit 72a, preferably on a free end 118a of the manipulator unit 72a. The tool unit 44a, in particular the interface device 46a, is arranged at the free end 118a of the manipulator unit 72a. It is contemplated that the robot-tool connection unit 48a may be designed as a rotary drive, an oscillatory drive or the like of the tool unit 44a, in particular of the tool.

The control unit 16a is provided so as to block or enable a machining step 158a planned for the object 68a by the machining unit 12a as a function of at least one surface characteristic of at least a part of a surface 84a of the object 68a to be machined. The machining plan has at least machining step 158a. The portion of the surface 84a has at least one surface to be machined in the machining step 158a. In particular, if the surface characteristic determined for the part of the surface 84a is within a limit range of a target value of the surface characteristic of the part of the surface 84a, the control unit 16a is provided so as to enable the planned machining step 158a. In particular, if the surface characteristic determined for the part of the surface 84a is outside a limit range to the target value of the surface characteristic of the part of the surface 84a, the control unit 16a is provided so as to block the planned machining step 158a. The target value of the surface characteristic of the part of the surface 84a and/or the associated limit range is stored, for example, on the memory element of the control unit 16a, in particular in the work environment model.

The surface characteristic may include at least information about a flatness of the portion of the surface 84a. In particular, the flatness of a surface corresponds to a value of a distance between two planes arranged parallel to each other, which are arranged at a minimum distance from each other, at which an entirety of the surface is arranged within the two planes. Furthermore, it is alternatively or additionally contemplated that the surface characteristic may have information on a material of the part of the surface 84a or the like. The surface characteristic or information for determining the surface characteristic is detected by the detection unit 30a, in particular the lidar unit of the detection unit 30a. Preferably, an alignment of the detection unit 30a is variable, in particular adjustable. Preferably, the detection unit 30a has an adjustment unit (not shown here) for adjusting an alignment of the detection unit 30a. Preferably, the adjustment unit 30a has a servomotor. The adjustment unit 30a is preferably connected to the control unit 16a at least for controlling purposes. Alternatively, it is contemplated that the detection unit 30a may be arranged on the machining unit 12a, in particular on the manipulator unit 72a, such that an alignment of the detection unit 30a is changed, in particular adjusted, by means of the manipulator unit 72a. The control unit 16a is provided so as to adjust an alignment of the detection unit 30a, in particular by controlling the adjustment unit, at least for detecting the at least one surface characteristic. Alternatively, it is contemplated that the autonomous work device 10a may have a further detection unit, in particular a further lidar unit or the like, separate from the detection unit 30a, for determining the surface characteristic or the information for determining the surface characteristic.

If the flatness determined for the part of the surface 84a is within a limit range of a target value for the flatness of the part of the surface 84a, the control unit 16a is provided so as to enable the planned machining step 158a. If the flatness determined for the part of the surface 84a is outside a limit range to the target value of the flatness of the part of the surface 84a, the control unit 16a is provided so as to block the planned machining step 158a. The target value of the flatness of the part of the surface 84a and/or the associated limit range is stored, for example, on the memory element of the control unit 16a, in particular in the work environment model.

The control unit 16a is provided so as to enable or block the machining step 158a planned for the object 68a by the machining unit 12a as a function of an obstacle detection in a machining area 86a of the part of the surface 84a of the object 68a. By means of the obstacle detection, information on obstacle objects 96a in the machining area 86a is detected. The detection unit 30a, in particular the lidar unit of the detection unit 30a, is provided for detecting obstacle objects 96a during obstacle detection. Alternatively, it is contemplated that the autonomous work device 10a may have a further detection unit, in particular separate from the detection unit 30a, for detecting obstacles.

The machining area 86a is a part of the work environment 26a, in particular an area around the part of the surface 84a in which the autonomous work device 10a, in particular the machining unit 12a and/or the locomotion unit 14a, moves when machining the object 68a, in particular when performing the planned machining step 158a. The part of the surface 84a is part of the machining area 86a. If an obstacle object 96a is detected in the machining area 86a during obstacle detection, the control unit 16a is provided so as to block the planned machining step 158a. If it is determinable during obstacle detection that the machining area 86a is free of obstacle objects 96a, the control unit 16a is provided so as to activate the planned machining step 158a.

If the flatness determined for the part of the surface 84a is outside a limit range to a target value of the flatness of the part of the surface 84a, the control unit 16a is provided so as to block the planned machining step 158a. The target value of the flatness of the part of the surface 84a and/or the associated limit range is stored, for example, on the memory element of the control unit 16a, in particular in the work environment model.

The control unit 16a is provided so as to determine blocked movement areas for the machining unit 12a depending on the obstacle detection. When an obstacle object 96a is detected in an area in the work environment 26a, the control unit 16a is provided so as to classify the area as a blocked movement area. The control unit 16a is provided so as to control the machining unit 12a and/or the locomotion unit 14a such that the autonomous work device 10a, in particular the machining unit 12a and/or the locomotion unit 14a, are always outside areas of the work environment 26a classified as blocked movement areas. For example, information on blocked movement areas may be stored on the memory element of the control unit 16a, in particular in the work environment model.

The control unit 16a is provided so as to compare at least information from the obstacle detection with the work environment model. By comparing information from obstacle detection with the work environment model, it is possible to determine whether an obstacle detected during obstacle detection is known in the work environment model.

It is contemplated that the control unit 16a may be provided so as to enable or block the planned machining step 158a depending on a comparison of information from the obstacle detection with the work environment model. For example, it is contemplated that the control unit 16a may enable the planned machining step 158a if the comparison of information from the obstacle detection with the work environment model shows that an obstacle object 96a detected during the obstacle detection is already known in the work environment model. It is also contemplated, for example, that the control unit 16a may be provided so as to block the planned machining step 158a if an obstacle object 96a detected during obstacle detection is unknown in the work environment model.

It is also contemplated that the control unit 16a may be provided so as to carry out a correction of the planned machining step 158a depending on a comparison of the work environment model with the information from the obstacle detection. For example, it is contemplated that a deviation in the position of an obstacle object 96a as it is known in the work environment model from the obstacle object 96a detected by the detection unit 30a in the work environment 26a may be determinable by the control unit 16a by comparing the work environment model with the information from the obstacle detection. For example, the control unit 16a may be provided so as to correct a machining coordinate, a machining angle, a machining duration, a machining intensity or the like of the planned machining step 158a as a function of the comparison of the work environment model with the information from the obstacle detection, in particular as a function of a position deviation of an obstacle object 96a known in the work environment model from the obstacle object 96a detected by the detection unit 30a in the work environment 26a, which deviation is determined by means of the control unit 16a.

The robot-tool connection unit 48a is designed to be modularly expandable for the arrangement of different interface functional modules. The interface modules are detachably attached to the robot-tool connection unit 48a. It is contemplated that at least some of the interface modules may be detachable without tools on the robot-tool connection unit 48a and/or without tools from the robot-tool connection unit 48a. In a state arranged on the robot-tool connection unit 48a, at least some of the interface modules are connected to the control unit 16a for data and/or control purposes, in particular cordlessly and/or corded. The control unit 16a is provided so as to control at least some of the interface modules. In a state of the tool unit 44a arranged on the robot-tool connection unit 48a, the tool unit 44a is connected to the control unit 16a for data and/or controlling purposes, in particular cordlessly and/or corded. It is contemplated that at least some of the interface modules may have at least one valve for controlling the function of the respective interface module. It is contemplated that the robot-tool connection unit 48a, in particular the control unit 16a, may be configured to automatically detect a connection to one of the interface modules. Furthermore, it is contemplated that the robot-tool connection unit 48a, in particular the control unit 16a, may be configured to automatically identify an interface module connected to the robot-tool connection unit 48a.

The robot-tool connection unit 48a has at least one module interface (not shown here), preferably a plurality of module interfaces, for attaching at least one interface module, preferably a plurality of interface modules. Preferably, the at least one module interface is configured for at least one mechanical connection to at least one of the interface modules. It is contemplated that the at least one module interface may be configured to provide an electrical connection to at least one of the interface modules, for example, for the supply of electrical power to the at least one interface module arrangeable on the module interface. Preferably, the at least one module interface is configured for data and/or control purposes with at least one interface module arranged on the module interface.

The interface device 46a has a sensor module 50a for detecting an environmental characteristic and/or the tool unit 44a. The sensor module 50a is one of the interface modules mentioned above. Alternatively, it is also contemplated that the interface device 46a may be designed free of a sensor module 50a. For example, the environmental characteristic may have information on a distance between the tool unit 44a and the object 68a to be machined or another object in the work environment 26a, a temperature, in particular a temperature of the object 68a, another object and/or an ambient air, an air humidity, a force acting on the robot-tool connection unit 48a, for example, when machining the object 68a by means of the machining unit 12a, information on a gas composition in the ambient air, in particular on hazardous gases in the ambient air, an ambient air pressure, information on persons present in the work area 26a, a combination thereof or the like.

The sensor module 50a may, for example, detect a connection, at least mechanical and/or electrical, between the robot-tool connection unit 48a and the tool unit 44a. In a state of the sensor module 50a arranged on the robot-tool connection unit 48a, the sensor module 50a is connected to the control unit 16a at least for data purposes, in particular cordlessly and/or corded. Preferably, the sensor module 50a has an optical sensor unit, for example, a lidar unit, a laser interferometer or the like, and/or a capacitive sensor unit, preferably to detect the tool unit 44a, in particular to detect information on a connection of the robot-tool connection unit 48a with the tool unit 44a. The optical sensor unit may be provided for detecting information on a distance between the tool unit 44a and the object 68a to be machined or another object in the work environment 26a or the like. Sensor elements of the sensor module 50a, in particular the optical sensor unit, are arranged on the robot-tool connection unit 48a in a vibration-decoupled manner relative to the tool unit 44a and/or the robot-tool connection unit 48a. Alternatively or additionally, it is contemplated that the sensor module 50a may have a temperature sensor, a humidity sensor, a barometer, a force sensor, a gas sensor or the like, or a combination thereof.

The interface device 46a has a power supply module 52a for transmitting power to the tool unit 44a arranged on the robot-tool connection unit 48a, in particular the hand-held power tool 122a. The power supply module 52a is one of the interface modules mentioned above. Alternatively, it is also contemplated that the interface device 46a may be designed free of a power supply module 52a. The tool unit 44a, in particular the hand-held power tool 122a, is supplied with electrical energy via the power supply module 52a. The power supply module 52a has at least one electrical interface (not shown here) for an electrical connection to the tool unit 44a, preferably the hand-held power tool 122a, in particular a power cord or a battery pack interface, of the tool unit 44a, in particular the hand-held power tool 122a. It is contemplated that the power supply module 52a may draw energy, in particular electrical energy, from an energy store (not shown here) of the autonomous work device 10a and/or that the power supply module 52a may have its own energy store, for example, a rechargeable battery, a battery, a solar module or the like. It is contemplated that the power supply module 52a may be connected to the control unit 16a for controlling and/or data purposes, in particular cordlessly and/or corded, preferably at least in a state of the power supply module 52a arranged on the robot-tool connection unit 48a. Alternatively, it is contemplated that the power supply module 52a may be designed free of a connection with the control unit 16a that is for data and/or control purposes.

The interface device 46a has a fluid transfer module 54a for transferring a fluid from the tool unit 44a arranged on the robot-tool connection unit 48a, in particular from the hand-held power tool 122a. The fluid transfer module 54a is one of the interface modules mentioned above. Alternatively, it is also contemplated that the interface device 46a may be designed free of a fluid transfer module 54a. The fluid transfer module 54a is one of the interface modules. The fluid transfer module 54a has at least one fluid interface (not shown here) for a fluid connection to an extraction element 136a, for example, a hose, a pipe, an air connection piece or the like, of the tool unit 44a, in particular of the hand-held power tool 122a. In particular, the fluid transfer module 54a is provided for extracting material that is generated by a machining of the object 68a by the machining unit 12a, in particular the tool unit 44a. The fluid transfer module 54a has a further fluid interface (not shown here) for a fluid connection with a extraction unit (not shown here), in particular a extraction hose 140a of the extraction unit. It is contemplated that the extraction unit may be part of the autonomous work device 10a or that the extraction unit may be designed separate from the autonomous work device 10a. Alternatively, it is also contemplated that the fluid transfer module 54a may have the extraction unit. For example, the extraction unit may have a blower or the like, in particular to generate an air flow for extracting a material. It is contemplated that the extraction unit may be designed as a vacuum cleaner or the like. The fluid transfer module 54a is provided so as to connect the tool unit 44a, in particular the extraction element 136a, to the extraction unit. It is contemplated that the fluid transfer module 54a may have at least one valve for controlling the function of the fluid transfer module 54a, in particular for controlling, preferably enabling and/or blocking a fluid transfer through the fluid transfer module 54a. It is contemplated that the fluid transfer module 54a, in particular the valve of the fluid transfer module 54a, may be connected to the control unit 16a for controlling and/or data purposes, preferably at least in a state of the fluid transfer module 54a arranged on the robot-tool connection unit 48a.

Alternatively or additionally, it is contemplated that the fluid transfer module 54a may be configured to transfer a fluid, in particular a liquid, preferably water, and/or air, to the tool unit 44a arranged on the robot-tool connection unit 48a, for example, for cleaning the tool and/or the object 68a to be machined, in particular during machining by the machining unit 12a, in particular the tool unit 44a. For example, the tool unit 44a may have a blow-out lance (not shown here) or the like that is provided so as to blow off material from a drill hole generated by the machining unit 12a, preferably by air transmitted via the fluid transfer module 54a.

Furthermore, it is alternatively or additionally contemplated that the fluid transfer module 54a may be provided for a fluidic drive of a tool unit 44a arranged on the robot-tool connection unit 48a, which in particular is designed to be driven by fluidic means. It is contemplated, for example, that a pneumatically drivable tool unit 44a may be pneumatically drivable by means of the fluid transfer module 54a or is connectable to a pneumatic drive unit via the fluid transfer module 54a. The pneumatic drive unit may be part of the autonomous work device 10a or separate from the autonomous work device 10a. For example, it is also contemplated that a hydraulically drivable tool unit 44a may be hydraulically driven by means of the fluid transfer module 54a or is connectable to a hydraulic drive unit via the fluid transfer module 54a. The hydraulic drive unit may be part of the autonomous work device 10a or designed separate from the autonomous work device 10a.

The interface device 46a has a detection module 56a for identifying the tool unit 44a arranged on the robot-tool connection unit 48a, in particular the hand-held power tool 122a. The detection module 56a is one of the interface modules mentioned above. Alternatively, it is also contemplated that the interface device 46a may be designed free of a detection module 56a. The detection module 56a is connected to the control unit 16a for data purposes, in particular cordlessly and/or corded, at least in a state arranged on the robot-tool connection unit 48a. For example, the detection module 56a may identify the tool unit 44a by means of RFID, mechanical coding, optical detection or the like, at least in a state of the tool unit 44a arranged at the robot-tool connection unit 48a. For example, the detection module 56a is configured to identify at least one tool type, a serial number or the like of the tool unit 44a, in particular of the hand-held power tool 122a, when identifying the tool unit 44a.

Alternatively or additionally, it is contemplated that the interface device 46a may have a material supply module 58a for supplying material to the tool unit 44a arranged on the robot-tool connection unit 48a. The material supply module 58a is one of the above-mentioned interface modules. For example, the material supply module 58a is configured to supply dowels, paint, adhesive, concrete or the like. It is contemplated that the material supply module 58a may be connected to a material reservoir, for example, which is part of the autonomous work device 10a or is designed separate from the autonomous work device 10a, or itself feature a material reservoir. In particular, the material reservoir may contain the material to be conveyed to the tool unit 44a via the material supply module 58a. For example, a material is conveyable to the tool unit 44a by means of a conveyor unit, in particular a pump, a compressor or the like, via the material supply module 58a. It is contemplated that the conveyor unit may be part of the material supply module 58a, part of the autonomous work device 10a or designed separate from the autonomous work device 10a. It is contemplated that the material supply module may have at least one valve for controlling the function of the material supply module 58a, in particular for controlling, preferably enabling or blocking a material transfer through the material supply module 58a. It is contemplated that the material feed module 58a, in particular the valve of the material feed module 58a, may be connected to the control unit 16a for controlling and/or data purposes, preferably at least in a state of the material feed module 58a arranged on the robot-tool connection unit 48a.

A connection between the tool unit 44a and the robot-tool connection unit 48a is producible and/or releasable manually and/or at least partially automatically. It is contemplated that the autonomous work device 10a may be is a tool magazine (not shown here). Alternatively, it is contemplated that the tool magazine may be designed separate from the autonomous work device 10a, preferably positioned stationary in the work environment 26a. For example, the tool magazine may have a plurality of different tool units. The interface device 46a is designed such that the tool units from the tool magazine are couplable manually and/or automatically to the robot-tool connection unit 48a. At least one mechanical connection of the tool unit 44a to the robot-tool connection unit 48a is producible, for example, by means of a latching connection, a clamp connection, a bayonet lock or the like. The latching connection may be made using a latching hook and/or a ball latch, for example. A connection of the robot-tool connection unit 48a to the tool unit 44a is based preferably on the poka-yoke principle. It is contemplated that the robot-tool connection unit 48a may have a servomotor or the like for automatically releasing the connection between the tool unit 44a and the robot-tool connection unit 48a. Alternatively or additionally, it is contemplated that the mechanical connection between the tool unit 44a and the robot-tool connection unit 48a may be releasable automatically by mechanically contacting the tool unit 44a and/or the robot-tool connection unit 48a with an object.

The interface device 46a has a cleaning unit 60a. The cleaning unit 60a is provided so as to at least partially automatically clean the robot-tool connection unit 48a and/or the tool unit 44a when the robot-tool connection unit 48a is connected to the tool unit 44a. The cleaning unit 60a is configured for fluidic cleaning. The cleaning unit 60a has a fluid channel 142a. Preferably, the fluid channel runs at least partially through the robot-tool connection unit 48a. By bringing the tool unit 44a closer to the robot-tool connection unit 48a, an air flow is producible in the fluid channel, which is used in particular for cleaning the tool unit 44a and/or the robot-tool connection unit 48a. Alternatively, it is also contemplated that the interface device 46a may be designed free of a cleaning unit 60a. It is contemplated that the cleaning unit 60a may be designed as one of the interface modules.

FIG. 4 shows a schematic sequence of a method for an at least partially automatic machining of the object 68a, in particular for an at least partially automatic production of drill holes in the object 68a by means of the autonomous work device 10a, in particular by means of the machining unit 12a.

In a step of the method, in particular in a classification step 100a, the test object 18a is classified as a localization reference object 20a as a function of a comparison of the nominal characteristic quantity of the at least one test object 18a in the work environment of the machining unit 12a and the actual characteristic quantity of the at least one test object 18a.

In a step of the method, in particular a check step 98a, a need for additional localization reference elements 22a is checked. Preferably, in particular in the check step 98a, subareas 90a, 92a of the work environment 26a are identified by means of the control unit 16a, in which localization of the machining unit 12a is possible by based on the at least one test object 18a. In particular, preferably in the check step 98a, it is checked whether in the subareas 90a, 92a relevant for the machining of the object 68a, in particular for the execution of the machining plan, preferably whether at the support points 28a, 94a relevant for machining the object 68a, in particular for executing the machining plan, a localization of the machining unit 12a based on the at least one test object 18a classified as a localization reference object 20a, is possible.

In a step of the method, in particular in an installation planning step 102a, a target installation position for the at least one additional localization reference element 22a is determined by means of the control unit 16a, at least as a function of a check of the need for additional localization reference elements 22a. It is contemplated that in a method step, in particular in the installation planning step 102, a target installation position determined for the at least one additional localization reference element 22a may be output via the output unit, projected onto the target installation position in the work environment 26a and/or stored in the work environment model.

In a step of the method, in particular in an installation step 134a, the at least one additional localization reference element 22a is attached at the target installation position of the additional localization reference element 22a, for example, manually by a user or automatically by the autonomous work device 10a, in particular by the machining unit 12a.

In a step of the method, in particular in a work step 104a, the object 68a is machined by means of the machining unit 12a. In the object 68a, in particular in the work step 104a, at least one drill hole is produced by means of the machining unit 12a. The machining unit 12a and/or the locomotion unit 14a is controlled by the control unit 16a, in particular in the work step 104a, during the machining of the object 68a and/or for localization in the work environment as a function of the at least one test object 18a classified as localization reference object 20a and/or as a function of the at least one additional localization reference element 22a.

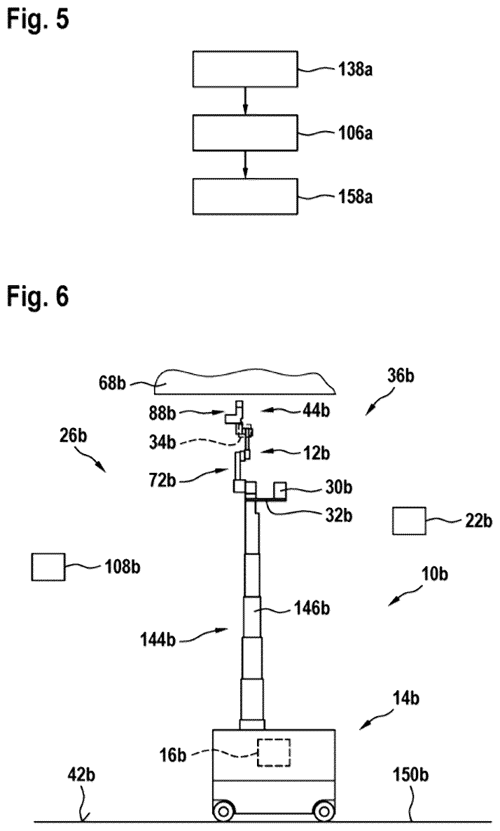

FIG. 5 shows a schematic sequence of a method, in particular of the work step 104a from FIG. 4, for at least partially automatic machining of the object 68a, in particular for at least partially automatic production of drill holes in the object 68a by means of the autonomous work device 10a. In a step of the method, in particular in an enabling step 138a, the machining step 158a planned for the object 68a is blocked or enabled by the machining unit 12a as a function of at least one surface characteristic of at least a part of the surface 84a of the object 68a.

In a step of the method, in particular in a correction step 106a, the planned machining step is corrected as a function of the comparison of the information from the obstacle detection in the machining area 86a of the machining unit 12a with the work environment model.

In a step of the method, in particular in the machining step 158a, the planned machining step 158a, which has been corrected in the correction step 106a, is carried out.

FIG. 6 to 13 show further exemplary embodiments of the invention. The following descriptions and the drawings are substantially limited to the differences between the exemplary embodiments, wherein reference may also be made in principle to the drawings and/or the description of the other exemplary embodiments, in particular FIGS. 1 to 5, with regard to identically described components, in particular with regard to components having the same reference numerals. To differentiate between the exemplary embodiments, the letter a is placed after the reference numerals of the exemplary embodiment in FIGS. 1 to 5. In the exemplary embodiments in FIG. 6 to 13, the letter a is replaced by the letters b to e.

FIG. 6 shows a system 36b with an autonomous work device. Alternatively, it is also contemplated that the work device 10b may be designed as a manual work device 10b and with at least one localization reference element 22b. The autonomous work device 10b is designed as a worksite robot, in particular as a drilling robot. Alternatively, however, it is also contemplated that the autonomous work device 10b may be designed as a worksite robot other than a drilling robot, for example, as a painting robot, as a window cleaning robot, as a sweeper robot, as an outdoor robot, for example, as a mulching robot, as a hedge-cutting robot, as a snow-clearing robot, as a collecting robot, in particular for collecting leaves, branches or the like, as a combination thereof or as another autonomous work device 10b which appears to a person skilled in the art to be useful. The autonomous work device 10b has a machining unit 12b. The machining unit 12b has a drilling unit 88b, in particular is designed as a drilling unit 88b. The autonomous work device 10b has a locomotion unit 14b for moving the machining unit 12b. The autonomous work device 10b has a control unit 16b at least for controlling the machining unit 12b.

The autonomous work device 10b has a detection unit 30b arranged on the locomotion unit 14b for detecting the at least one localization reference element 22b. The detection unit 30b has, for example, a theodolite, a tachymeter or the like for detecting the localization reference element 22b. The detection unit 30b, in particular the theodolite or the tachymeter, is configured to automatically detect the localization reference element 22b, in particular by means of the control unit 16b. The localization reference element 22b is designed, for example, as a reflective marker, in particular as a triple mirror, as reflective foils, or the like.

The control unit 16b is provided so as to control the machining unit 12b and/or the locomotion unit 14b to move the machining unit 12b and/or the locomotion unit 14b of the work environment 26b and/or to machine an object 68b by the machining unit 12b as a function of at least one localization reference element 22b arranged in the work environment 26b. Alternatively or additionally, however, it is also contemplated that the detection unit 30b may have a lidar unit, a stereo camera, a time-of-flight camera, a camera system based on fringe projection and/or other detection means that would appear useful to a person skilled in the art for localizing the autonomous work device 10b, in particular the locomotion unit 14b and/or the machining unit 12b.

The control unit 16b is provided so as to evaluate the information recorded by the detection unit 30b based on a simultaneous localization and mapping (SLAM) method, preferably for a movement of the autonomous work device 10b, preferably the machining unit 12b and/or the locomotion unit 14b, to a working position of the autonomous work device 10b, in particular the locomotion unit 14b. The working position of the autonomous work device 10b may only feature information on a position of the autonomous work device 10b, in particular the locomotion unit 14b. The working position is free of information on an alignment, in particular on rotational positions, of the machining unit 12b, preferably to the part of the machining unit 12b. The working position is stored in the machining plan, in particular in the work environment model. The control unit 16b is provided so as to move the autonomous work device 10b, in particular the machining unit 12b and/or the locomotion unit 14b, to the working position for machining the at least one object 68b as a function of the machining plan and as a function of the information detected by means of the detection unit 30b.

The control unit 16b is provided so as to determine a position and an alignment of at least a part of the machining unit 12b at least as a function of the localization reference element 22b detected by means of the detection unit 30b. The determining of a position and an alignment of at least the part of the machining unit 12b comprises a determination of a position and all rotational positions of the part of the machining unit 12b. The part of the machining unit 12b may correspond here, by way of example, to a tool unit 44b of the machining unit 12b, in particular a tool, in particular a tool arranged on a hand-held machine tool of the tool unit 44b, of the tool unit 44b. The control unit 16b is provided so as to determine the position and the alignment of at least the part of the machining unit 12b after moving the autonomous work device 10b, in particular the machining unit 12b and/or the locomotion unit 14b, to the working position, preferably with the locomotion unit 14b in a fixed position.

The autonomous work device 10b may have a height-adjustable work platform 32b. The work platform 32b is arranged on the locomotion unit 14b. The detection unit 30b is arranged on the work platform 32b. A manipulator unit 72b of the machining unit 12b is arranged on the work platform 32b. The work platform 32b is height-adjustable relative to a subsurface 150b on which the autonomous work device 10b, in particular the locomotion unit 14b, is arranged. The autonomous work device 10b has a lifting unit 144b. The work platform 32b is height-adjustable by means of the lifting unit 144b. The lifting unit 144b has a telescopic rod 146b. The telescopic rod 146b is designed as a hydraulic telescopic rod. Alternatively, it is also contemplated that the lifting unit 144b may have more than one telescopic rod 146b. Furthermore, it is alternatively or additionally contemplated that the lifting unit 144b may have a scissor lift mechanism, a linear drive, for example, a toothed rack, a push chain, a ball screw drive, a linear motor, or the like. The work platform 32b is connected to the locomotion unit 14b via the lifting unit 144b, in particular the telescopic rod 146b. The lifting unit 144b is connected to the control unit 16b for controlling purposes, in particular cordlessly and/or corded. The lifting unit 144b is part of the machining unit 12b. Alternatively, it is also contemplated that the work platform 32b may be arranged on the manipulator unit 72b of the machining unit 12b such that the work platform 32b is adjusted in height by means of the manipulator unit 72b. The manipulator unit 72b is designed as a robot arm. The manipulator unit 72b has multi-axis kinematics. The manipulator unit 72b has six degrees of freedom. Alternatively, however, it is also contemplated that the manipulator unit 72b may have fewer than six degrees of freedom.

The autonomous work device 10b has an inclinometer 34b. The inclinometer 34b is provided for determining an inclination relative to an installation plane 42b of the autonomous work device 10b, in particular the locomotion unit 14b. The control unit 16b is provided so as to determine the position and the alignment of at least the part of the machining unit 12b in a work environment model as a function of measured variables determined by means of the detection unit 30b and the inclinometer 34b. The inclinometer 34b may be designed as a mechanical inclinometer, an electrical inclinometer or a digital inclinometer.

The control unit 16b is provided so as to use at least one measured variable of the inclinometer 34b for a vertical alignment of the manipulator unit 72b of the machining unit 12b. The control unit 16b is provided so as to transform a coordinate system of the manipulator unit 72b into a vertical position as a function of an inclination of the manipulator unit 72b relative to the installation plane 42b determined by means of the inclinometer 34b. Preferably, the autonomous work device 10b, in particular the locomotion unit 14b, is in a fixed position when measured variables are detected by the inclinometer 34b and/or the detection unit 30b to determine a position and an alignment of at least the part of the machining unit.

The control unit 16b is provided so as to process at least one measured variable of the inclinometer 34b to support a detection of the at least one localization reference element 22b. The at least one measured variable of the inclinometer 34b is used to support automatic detection of the at least one localization reference element 22b by the detection unit 30b by means of the control unit 16b.

The control unit 16b is provided so as to check a need for additional localization reference elements 108b. The control unit 16b is provided so as to check and/or determine a need for additional localization reference elements 108b as a function of the machining plan, in particular as a function of the at least one working position. The control unit 16b is provided so as to determine, as a function of the machining plan, preferably as a function of the at least one working position, and/or on the basis of information on the work environment 26b determined by means of the detection unit 30b, at least one need for additional localization reference elements 108b, which the control unit 16b needs in order to enable determination of the position and alignment of the part of the machining unit 12b in the entire work environment 26b or in a part of the work environment 26b that is relevant with regard to machining of the at least one object 68b. An extension of the part of the work environment 26b relevant with regard to machining of the at least one object 68b depends in particular on the machining plan, preferably the at least one working position.

The control unit 16b is provided so as to determine a target installation position for at least one additional localization reference element 108b depending on a check of the need for additional localization reference elements 108b. For example, the autonomous work device 10b may comprise an output unit (not shown here). For example, the output unit is designed as an optical output unit, an acoustic output unit, a haptic output unit or a combination thereof. The output unit may have, for example, a screen, a loudspeaker, a light element, such as an LED, or the like. It is contemplated that the output unit may be provided so as to output the target installation position. For example, it is contemplated that the target installation position may be displayed on a screen of the output unit and/or that the output unit is configured for a projection of the target installation position in the work environment 26b. Alternatively or additionally, it is also contemplated that the autonomous work device 10b, in particular the machining unit 12b, may be configured to at least partially automatically attach the additional localization reference element 108b at the target installation position.

The control unit 16b is provided so as to determine an actual position of the additional localization reference element 108b by means of the detection unit 30b, in particular the theodolite or the tachymeter. The control unit 16b is provided so as to store the actual position of the additional localization reference element 108b on the memory element of the control unit 16b, in particular in the work environment model. The additional localization reference element 108b is usable to localize the autonomous work device 10b, in particular the machining unit 12b and/or the locomotion unit 14b, in the work environment 26b and/or to determine the position and alignment of at least the part of the machining unit 12b.

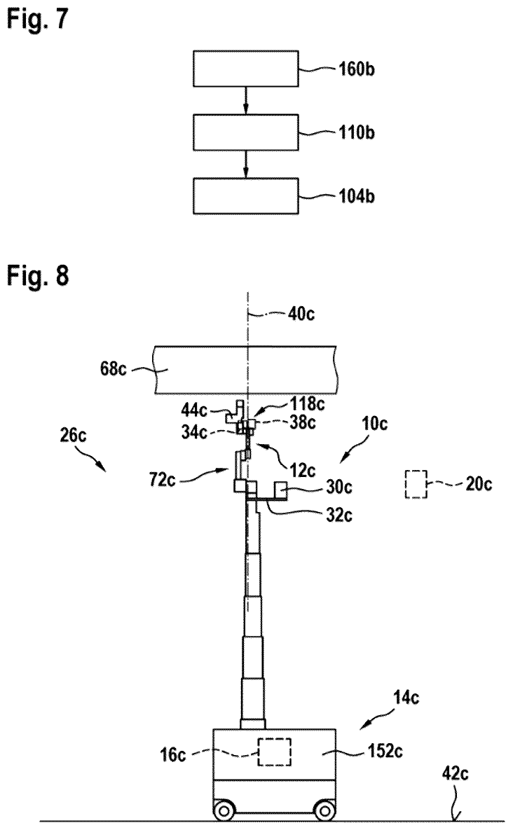

FIG. 7 shows a schematic sequence of a method for at least partially automatic machining of the object 68b, in particular for at least partially automatic production of drill holes in the object 68b by means of the autonomous work device 10b.

In a step of the method, in particular in a localization step 160b, the autonomous work device 10b, in particular the locomotion unit 14b, is moved in the work environment 26b as a function of information on the work environment 26b acquired by means of the detection unit 30b, in particular as a function of the at least one localization reference element 22b, preferably by means of actuation by the control unit 16b. The autonomous work device 10b, preferably the locomotion unit 14b, is controlled by the control unit 16b, in particular in the localization step 160b, to move the autonomous work device 10b to the working position of the machining unit 12b as a function of information acquired by means of the detection unit 30b. It is contemplated that, in particular in the localization step 106b, a measured variable determined by means of the inclinometer 34b may be processed by the control unit 16b to support an automatic detection of the at least one localization reference element 22b by the detection unit 30b.

In a step of the method, in particular in a position determination step 110b, a position and an alignment of at least the part of the machining unit 12b are determined at least as a function of the localization reference element 22b detected by means of the detection unit 30b arranged on the locomotion unit 14b. The autonomous work device 10b, in particular the locomotion unit 14b, are located at a fixed position, in particular at the working position, in particular when measured variables are detected by the inclinometer 34b and/or the detection unit 30b for determining a position and an alignment of at least the part of the machining unit 12b.

In a step of the method, in particular in a work step 104b, the object 68b is machined by means of the machining unit 12b. In the object 68b, in particular in the work step 104b, at least one drill hole is produced by means of the machining unit 12b. The machining unit 12b and/or the locomotion unit 14b are/is controlled by the control unit 16b, in particular in the work step 104b, during the machining of the object 68b as a function of the position and alignment of at least the part of the machining unit 12b in the work environment model, in particular determined in the position determination step 10b.

FIG. 8 shows an autonomous work device 10c. Alternatively, it is also contemplated that the work device 10c may be designed as a manual work device 10c. The autonomous work device 10c is designed as a worksite robot, in particular as a drilling robot. Alternatively, however, it is also contemplated that the autonomous work device 10c may be designed as a worksite robot other than a drilling robot, for example, as a painting robot, as a window cleaning robot, as a sweeping robot, as an outdoor robot, for example, as a mulching robot, as a hedge-cutting robot, as a snow-clearing robot, as a collecting robot, in particular for collecting leaves, branches or the like, as a combination thereof or as another autonomous work device 10c which appears to a person skilled in the art to be useful. The autonomous work device 10c has a machining unit 12c. The machining unit 12c is designed as a drilling unit.

The autonomous work device 10c has a locomotion unit 14c for moving the machining unit 12c. The autonomous work device 10c has a control unit 16c at least for controlling the machining unit 12c.

The autonomous work device 10c has at least one detection unit 30c. The control unit 16c is provided so as to control the autonomous work device 10c, in particular the locomotion unit 14c and/or the machining unit 12c, as a function of information acquired by means of the detection unit 30c. The detection unit 30c is at least partially designed as an optical detection unit. The detection unit 30c may have, for example, at least one lidar unit for detecting a work environment 26c. Alternatively or additionally, it is also contemplated that the detection unit 30c may have a stereo camera, a time-of-flight camera, a camera system based on fringe projection and/or other detection means that would appear useful to a person skilled in the art. The control unit 16c is provided so as to evaluate the information recorded by the detection unit 30c, in particular the lidar unit, based on a simultaneous localization and mapping (SLAM) method. In particular, the simultaneous localization and mapping (SLAM) method is a method for simultaneous position determination and map generation in robotics, wherein in particular within the method, preferably simultaneously, a virtual map of an environment and a spatial position of a movable unit, in particular of the autonomous work device 10c, is determined within the virtual map. The control unit 16c is provided so as to control the locomotion unit 14c during a movement in the work environment 26c as a function of information on the work environment 26c acquired by means of the detection unit 30c, preferably the lidar unit.

The autonomous work device 10c has an inclinometer 34c. The inclinometer 34c is provided so as to determine an inclination relative to an installation plane 42c of the autonomous work device 10c, in particular the locomotion unit 14c. The inclinometer 34c may be designed as a mechanical inclinometer, an electrical inclinometer or a digital inclinometer.

The autonomous work device 10c has a distance measuring instrument 38c. The distance measuring instrument 38c is designed as an electro-optical distance measuring instrument, in particular as a laser interferometer. Alternatively, it is also contemplated that the distance measuring instrument 38c may be designed as an optical distance measuring instrument. The distance measuring instrument 38c is provided so as to determine the distance to objects in the work environment. The distance measuring instrument 38c is arranged on the machining unit 12c. The control unit 16c is provided so as to determine a position and an alignment of at least a part of the machining unit 12c in a work environment model as a function of measured variables determined by means of the inclinometer 34c and the distance measuring instrument 38c. The determining of a position and an alignment of at least the part of the machining unit 12c may comprise a determination of a position and all rotational positions of the part of the machining unit 12c. By way of example, the part of the machining unit 12c may correspond here to a tool unit 44c of the machining unit 12c, in particular a tool, for example, a tool arranged on a hand-held power tool, of the tool unit 44c.

The control unit 16c is provided so as to use at least one measured variable of the inclinometer 34c to align the distance measuring instrument 38c. The control unit 16c is provided so as to use at least one measured variable of the inclinometer 34c for a vertical alignment of a manipulator unit 72c of the machining unit 12c. The control unit 16c is provided so as to transform a coordinate system of the manipulator unit 72c into a vertical position as a function of an inclination of the manipulator unit 72c relative to the installation plane 42c determined by means of the inclinometer 34c. The control unit 16c is provided so as to control the machining unit 12c and/or the locomotion unit 14c after a transformation of the coordinate system of the manipulator unit 72c into the vertical position for a movement of the machining unit 12c to a machining position of the machining unit 12c.

The machining position only contains information on a position of the autonomous work device, in particular the machining unit 12c. The machining position is at least free of information on an alignment, in particular on rotational positions, of the machining unit 12c, preferably on the part of the machining unit 12c. The machining position is stored in the machining plan, in particular in the work environment model. The autonomous work device 10c, in particular the locomotion unit 14c, is in a fixed position, in particular when measured variables are detected by the inclinometer 34c and/or the distance measuring instrument 38c to determine a position and an alignment of at least the part of the machining unit 12c.

The distance measuring instrument 38c is provided so as to detect, in a state of the distance measuring instrument 38c aligned by means of the inclinometer 34c, a measured variable in at least two different angular positions for determining the position and the alignment of the part of the machining unit 12c in the work environment model. The distance measuring instrument 38c is arranged, in particular in a state aligned by means of the inclinometer 34c, such that a detection direction of the distance measuring instrument 38c in a vertically aligned state of the manipulator unit 72c extends in a plane that is at least substantially perpendicular to the axis 40c when the manipulator unit 72c is rotated about an axis 40c. The axis 40c runs in the perpendicular direction. The control unit 16c is provided so as to control the manipulator unit 72c to rotate about the axis 40c such that the distance measuring instrument 38c detects a measured variable in the at least two different angular positions. The control unit 16c is provided so as to determine an actual position in the work environment 26c of at least one object classified as a localization reference object 20c in the work environment model and, in particular, to compare it with a target position from the work environment model.

The object classified as localization reference object 20c may be, for example, a wall, the object to be machined, a ceiling, a floor, a facade, another, preferably stationary, part of a building or stationary, in particular stationary, object in the work environment 26c. It is contemplated that objects may be automatically classified as localization reference object 20c by the autonomous work device 10c and/or manually by a user. An object is classified as a localization reference object 20c by means of the control unit 16c, in particular by comparing a nominal characteristic of the object and an actual characteristic of the object. The control unit 16c is provided so as to determine a deviation of the actual characteristic from the nominal characteristic when comparing the nominal characteristic of the object with the actual characteristic of the object. The control unit 16c is provided so as to classify the object as a localization reference object 20c if a value of the deviation of the actual characteristic variable from the nominal characteristic variable is within a tolerance range to a value of the nominal characteristic variable. If a value of the deviation of the actual characteristic from the nominal characteristic is outside the tolerance range for a value of the nominal characteristic, the object is excluded in particular from classification as a localization reference object 20c by the control unit 16c. The tolerance range is defined in the operating program, in particular in the work environment model. It is contemplated that the tolerance range may be adjusted, in particular manually by an operator and/or automatically by the control unit 16c, for example, depending on information stored in the work environment model. It is also contemplated that different tolerance ranges may be assigned to different objects in the work environment 26c in the work environment model.

The control unit 16c is provided so as to determine a standard of the localization reference object 20c from the comparison of the actual position with the target position. The control unit 16c is provided so as to use the actual position of the object classified as localization reference object 20c in the work environment 26c and its standard to determine the position and alignment of the part of the machining unit 12c in the work environment model. Preferably, the control unit 16c is provided for converting an entirety of coordinates from the machining plan into the coordinate system of the manipulator unit 72c, in particular into a coordinate system of at least the part of the machining unit 12, from the determined alignment and position of at least the part of the machining unit 12c. Preferably, the control unit 16c is provided so as to control the machining unit 12c and/or the locomotion unit 14c for machining an object 68c as a function of the determined alignment and position of at least the part of the machining unit 12c.

The autonomous work device 10c has a height-adjustable work platform 32c. The work platform 32c is arranged on the locomotion unit 14c. The distance measuring instrument 38c is arranged on the work platform 32c. The distance measuring instrument 38c is arranged on the manipulator unit 72c, in particular on a free end 118c of the manipulator unit 72c. The inclinometer 34c is arranged on the work platform 32c. The inclinometer 34c is arranged on the manipulator unit 72c, in particular arranged at the free end 118c of the manipulator unit 72c. Alternatively, it is also contemplated that the inclinometer 34c may be arranged separate from the manipulator unit 72c, in particular the machining unit 12c, on the work platform 32c or that the inclinometer 34c is arranged on, in particular in, a housing 152c of the autonomous work device 10c, in particular the locomotion unit 14c.

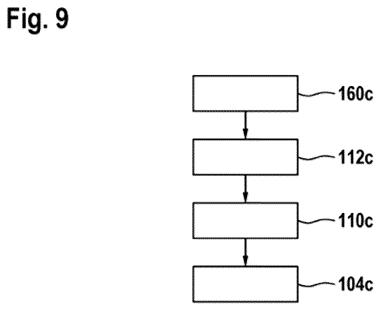

FIG. 9 shows a schematic sequence of a method for at least partially automatic machining of the object, in particular for at least partially automatic production of drill holes in the object by means of the autonomous work device 10b.

In a step of the method, in particular in a localization step 160c, the autonomous work device 10c, in particular the locomotion unit 14c, is moved in the work environment 26c as a function of information about the work environment 26c acquired by means of the detection unit 30c, preferably the lidar unit, preferably by means of control by the control unit 16c. The autonomous work device 10c, preferably the locomotion unit 14c, is controlled by the control unit 16c, in particular in the localization step 160c, to move the autonomous work device 10c to an area of the machining position of the machining unit 12c as a function of information acquired by means of the detection unit 30c, preferably the lidar unit.

In a step of the method, in particular in a detection step 112c, the distance measuring instrument 38c is aligned by means of the inclinometer 34c before a measured variable is detected. The distance measuring instrument 38c is rotated about the axis 40c, in particular in the detection step 112c, to detect one measured variable in each of the at least two angular positions. The distance measuring instrument 38c may detect, in particular in the detection step 112c, at least one measured variable in at least two different angular positions in a state aligned by means of the inclinometer 34c.

The autonomous work device 10c, in particular the locomotion unit 14c, is in a fixed position, in particular when measured variables are detected by the inclinometer 34c and/or the distance measuring instrument 38c to determine a position and an alignment of at least the part of the machining unit 12c.

In a step of the method, in particular in a positioning step 110c, the position and the alignment of at least the part of the machining unit 12c in the work environment model is determined as a function of measured variables determined by means of the inclinometer 34c and by means of the distance measuring instrument 38c.

In a step of the method, in particular in a work step 104c, the object 68c is machined by means of the machining unit 12c. In the object 68c, in particular in the work step 104c, at least one drill hole is produced by means of the machining unit 12c. The machining unit 12c and/or the locomotion unit 14c is controlled by the control unit 16c, in particular in the work step 104c, during the machining of the object 68c as a function of the position and alignment of at least the part of the machining unit 12c in the work environment model, in particular determined in the position determination step 110c.

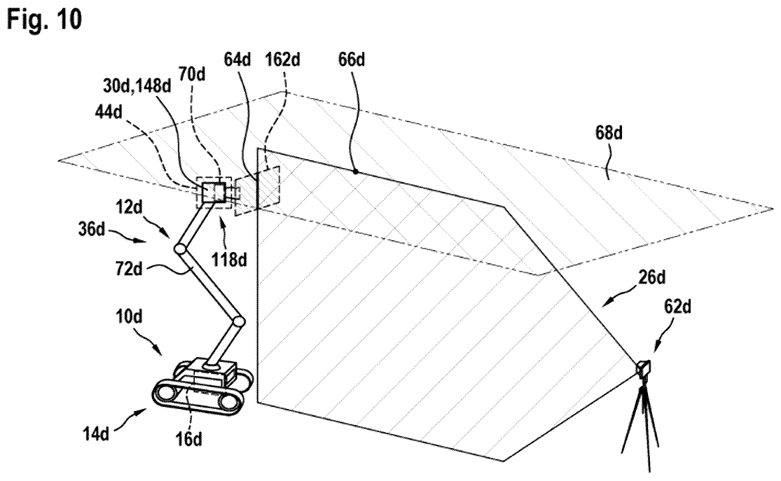

FIG. 10 shows a system 36d with an autonomous work device 10d. Alternatively, it is also contemplated that the work device 10d may be designed as a manual work device 10d. The autonomous work device 10d is designed as a worksite robot, in particular as a drilling robot.

Alternatively, however, it is also contemplated that the autonomous work device 10d may be designed as a worksite robot other than a drilling robot, for example, as a painting robot, as a window cleaning robot, as a sweeper robot, as an outdoor robot, for example, as a mulching robot, as a hedge-cutting robot, as a snow-clearing robot, as a collecting robot, in particular for collecting leaves, branches or the like, as a combination thereof or as another autonomous work device 10d which appears to a person skilled in the art to be useful.

The autonomous work device 10d has a machining unit 12d. The machining unit 12d is designed as a drilling unit. The autonomous work device 10d has a locomotion unit 14d for moving the machining unit 12d. The autonomous work device 10d has a control unit 16d at least for controlling the machining unit 12d. The autonomous work device 10d is provided for at least partially automatic machining of an object 68d, in particular by means of the machining unit 12d. The autonomous work device 10d is provided here as an example for at least partially automatic production of drill holes in the object 68d.

The machining unit 12d is provided, for example, to machine at least the object 68d according to a machining plan. The machining plan is stored on the memory element of the control unit 16d, for example. A work environment model of a work environment 26d of the autonomous work device 10d, in particular the machining unit 12d, is stored on the control unit 16d, in particular the memory element of the control unit 16d. The work environment model is a building information modeling (BIM) model or the like. The machining plan is registered in the work environment model. The control unit 16d is provided so as to navigate the locomotion unit 14d and/or the machining unit 12d in the work environment 26d, at least on the basis of the machining plan and/or the work environment model.

The autonomous work device 10d has a detection unit 30d. The detection unit 30d is designed as an optical detection unit. The detection unit 30d has a camera 148d. The detection unit 30d, in particular the camera 148d, has an image sensor (not shown here).

It is contemplated that the control unit 16d may be provided so as to evaluate the information recorded by the camera for localization, in particular for a movement, of the autonomous work device 10d, in particular the machining unit 12d and/or the locomotion unit 14d, in the work environment 26d, in particular for a working position. Furthermore, it is alternatively or additionally contemplated that the camera may be provided so as to acquire a surface characteristic or information for determining the surface characteristic in an intended machining area 86d of the object 68d. The working position of the autonomous work device 10d is a position of the autonomous work device 10d, in particular of the locomotion unit 14d, in the work environment 26d, at which the object 68d is machined by the machining unit 12d, in particular by means of an optical localization element 64d.

The system 36d has a projection unit 62d at least for generating the optical localization element 64d. The optical localization element 64d is designed as a line element. The optical localization element 64d is formed by electromagnetic radiation, preferably visible light. The optical localization element 64d is a laser line. The projection unit 62d has a line laser for generating the optical localization element 64d. Alternatively or additionally, it is contemplated that the projection unit 62d has a projector or the like for generating the optical localization element 64d. Preferably, the optical localization element 64d has a rectilinear course. Alternatively, however, it is also contemplated that the optical localization element 64d may be designed as a circle, a dot or the like.

The projection unit 62d, in particular a projection of the optical localization element 64d, is aligned at a marking point 66d. The marking point 66d is defined by a marking element arranged in the work environment 26d, in particular on the object 68d to be machined. Alternatively or additionally, it is contemplated that the marking point 66d may be stored in the work environment model. In this example, the marking element is a drill hole. Alternatively, however, it is also contemplated that the marking element may be a reflective pin, a luminous element, for example, an LED, a color marker, a shape marker, a combination thereof or the like. It is contemplated that the marking element may be automatically attachable and/or producible at the marking point 66d by the autonomous work device 10d, in particular the machining unit 12d. Alternatively, it is also contemplated that the marking element may be attachable and/or producible at the marking point 66d by a user or by a control of the autonomous work device 10d by the user, or that the marking element is producible and/or attachable at the marking point 66d using a device separate from the autonomous work device 10d, for example, a drilling machine.

For example, the projection unit 62d is aligned by a user at the marking point 66d. Alternatively, however, it is also contemplated that the projection unit 62d may be configured for automatic alignment, in particular without user intervention, for example, by means of a detection unit for detecting the marking point 66d or the like. The projection unit 62d is separate from the autonomous work device 10d. The projection unit 62d is provided so as to project the optical marking element 64d, in particular the line element, onto the machining area 86d and directly onto the detection unit 30d, in particular the image sensor, in particular simultaneously. The projection unit 62d is provided so as to project the optical localization element 64d directly onto the detection unit 30d, preferably the image sensor. In particular, the projection unit 62d is configured and/or arranged in such a way that the optical localization element 64d does not encounter any reflective surfaces or the like between the projection unit 62d and the detection unit 30d, in particular the image sensor.

The control unit 16d is provided so as to control the locomotion unit 14d and/or the machining unit 12d as a function of the optical localization element 64d projected directly onto the detection unit 30d, in particular the image sensor, in particular for machining the object 68d, preferably at at least one machining point of the object 68d. The control unit 16d is provided so as to control the locomotion unit 14d and/or the machining unit 12d such that the optical localization element 64d is detected by the detection unit 30d, preferably projected onto the detection unit 30d, preferably directly. It is contemplated that information on a target position of the at least one machining point may be stored in the machining plan, in particular in the work environment model. In particular, the machining point is different from the marking point 66d.

The control unit 16d is provided so as to control at least the machining unit 12d and, in particular, if necessary, the locomotion unit 14d to machine the object 68d along a machining line, in particular to produce drill holes along the machining line. The at least one machining point is located in particular on the machining line. The machining line is predetermined by the optical localization element 64d in the work environment 26d. It is contemplated that information on the machining line, in particular on a position of the machining line, may be stored in the machining plan, preferably in the work environment model. The control unit 16d is provided so as to control the machining unit 12d and, in particular, if necessary, the locomotion unit 14d during machining of the object 38d along the machining line, in particular the machining point, as a function of the optical localization element 64d projected directly onto the detection unit, in particular the image sensor.

The machining unit 12d has a manipulator unit 72d. A tool unit 44d of the machining unit 12d is arranged on the manipulator unit 72d, in particular on a free end 118d of the manipulator unit 72d. The detection unit 30d is arranged on the manipulator unit 72d. The tool unit 44d is provided for machining the object 68d. By way of example, the tool unit 44e is configured here at least to produce drill holes.

The control unit 16d is provided so as to align the manipulator unit 72d, in particular the tool unit 44d, as a function of the optical localization element 64d. The control unit 16d is provided so as to align the manipulator unit 72d, in particular the tool unit 44d, as a function of the localization element 64d for machining the object 68d, preferably along the machining line, preferably for machining the at least one machining point. The control unit 16d is provided, for example, to control the machining unit 12d and, if necessary, the locomotion unit 14d in such a way that the optical localization element 64d projected directly onto the detection unit 30d is arranged centrally on the image sensor. Because the control unit 16d controls the machining unit 12d and/or the locomotion unit 14d in such a way that the optical localization element 64d projected directly onto the detection unit 30d is arranged centrally on the image sensor, the manipulator unit 72d, in particular the tool unit 44d, is alignable.

The image sensor has a rectangular sensor surface 162d. FIG. 10 schematically shows the sensor surface 162d and the localization element 64d arranged centrally on the image sensor, in particular the sensor surface 162d. Alternatively, it is also contemplated that the sensor surface 162d may be square, circular or has another surface shape that appears to a person skilled in the art to be useful. When the optical localization element 64d is arranged centrally on the image sensor, a main extension axis of the optical localization element 64d may extend perpendicular to a main extension axis of the sensor surface 162d and, in particular, parallel to a main extension plane of the sensor surface 162d. In a central arrangement of the optical localization element 64d projected onto the detection unit 30d, the main extension axis of the optical localization element 64d extends through a geometric center of the sensor surface 162d.

The optical localization element 64d projected directly onto the detection unit 30d, in particular the image sensor, has a width. The width of the optical localization element 64d directly projected onto the detection unit 30d, in particular the image sensor, is perpendicular to the main extension axis of the optical localization element 64d directly projected onto the detection unit 30d, in particular the image sensor. The center of the optical localization element 64d is projected directly onto the detection unit 30d, in particular the image sensor, refers to the width. In particular, the control unit 16d is provided so as to use an algorithm to determine the center. The control unit 16d is provided, for example, to apply the algorithm to an image acquired by the acquire unit 30d, in particular the camera 148d. For example, to determine the center of the optical localization element 64d projected directly onto the detection unit 30d, preferably the image sensor, the control unit 16d is configured to use an algorithm analogous to a method by Lu Yonghua, Zhang Jia, Li Xiaoyan et al. (see Lu Yonghua, Zhang Jia, Li Xiaoyan. A robust method for adaptive center section of linear structured light stripe. Transactions of Nanjing University of Aeronautics and Astronautics. 2020, 37(4); 586-596).

The detection unit 30d has a bandpass filter 70d adapted to the localization element 64d. The bandpass filter 70d is provided so as to allow only one wavelength range of the optical localization element 64d to pass.

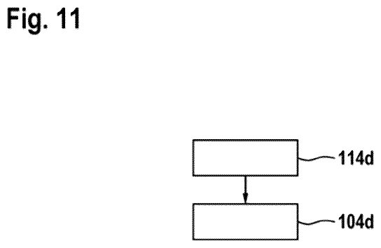

FIG. 11 shows a schematic sequence of a method for an at least partially automatic machining of the object 68d, in particular for an at least partially automatic production of drill holes in the object 68d by means of the system 36d. In a step of the method, in particular in a marking step 114d, a marking element is arranged or produced at the marking point 66d. A projection of the optical localization element 64d, in particular the projection unit 62d, is aligned, preferably in the marking step 114d, at the marking point 66d, in particular at the marking element.

The machining unit 12d and/or the locomotion unit 14d are/is controlled in a method step, in particular in a work step 104d, as a function of the optical localization element 64d projected directly onto the detection unit 30d, preferably in the form of a line element. The machining unit 12d and/or the locomotion unit 14d are/is controlled during machining of the object 68d, preferably during machining of the object 68d along the machining line, as a function of the optical localization element 64d projected directly onto the detection unit 30d, preferably in the form of a line element.

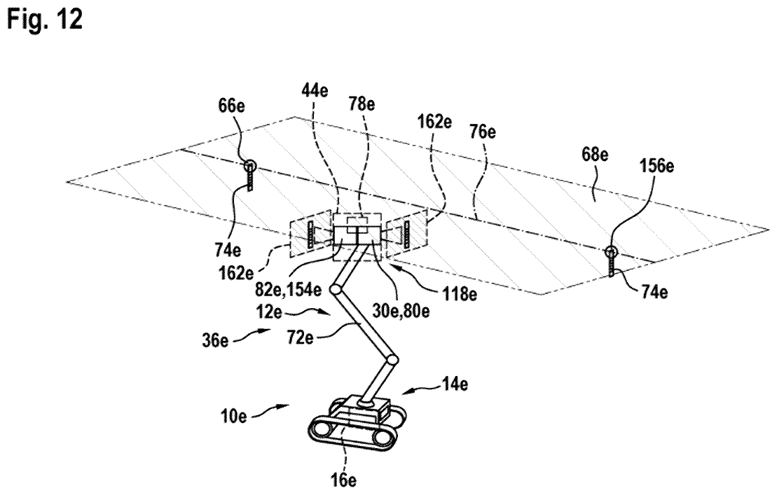

FIG. 12 shows a system 36e with an autonomous work device 10e. Alternatively, it is also contemplated that the work device 10e may be designed as a manual work device 10e. The autonomous work device 10e has a machining unit 12e. The machining unit 12e is designed as a drilling unit. The autonomous work device 10e is designed as a worksite robot, in particular as a drilling robot. Alternatively, however, it is also contemplated that the autonomous work device 10e may be designed as a worksite robot other than a drilling robot, for example, as a painting robot, as a window cleaning robot, as a sweeping robot, as an outdoor robot, for example, as a mulching robot, as a hedge-cutting robot, as a snow-clearing robot, as a collecting robot, in particular for collecting leaves, branches or the like, as a combination thereof or as another autonomous work device 10e which appears useful to a person skilled in the art.

The autonomous work device 10e has a locomotion unit 14e for moving the machining unit 12e. The autonomous work device 10e has a control unit 16e at least for controlling the machining unit 12e. The autonomous work device 10e is provided for at least partially automatic machining of an object 68e, in particular by means of the machining unit 12e. The autonomous work device 10e is provided here as an example for at least partially automatic production of drill holes in the object 68e.

The system 36e has at least two localization elements 74e. Alternatively, however, it is also contemplated that the system 36e may have a plurality of localization elements 74e, in particular more than two localization elements 74e. The localization elements 74e is designed here as reflective pins, for example. Alternatively, however, it is also contemplated that the localization elements 74e may be designed as light elements, for example, LEDs, color markers, shape markers, as a combination thereof or the like. A localization element 74e of the two localization elements 74e is arranged at a first marking point 66e. A further localization element 74e of the two localization elements 74e is arranged at a second marking point 156e.

The marking points 66e, 156e are each defined by a marking element arranged in a work environment 26e of the machining unit 12e, in particular on the object 68e to be machined. It is additionally or alternatively contemplated that the marking points 66e, 156e may be stored in a work environment model of the work environment of the machining unit 12e. The marking elements are drill holes. Alternatively, it is contemplated that the marking elements may be luminous elements, for example, LEDs, color markers, shape markers, a combination thereof or the like. In particular, the marking elements are producible automatically by the autonomous work device 10e, preferably the machining unit 12e, at the marking points 66e, 156e. Alternatively, it is also contemplated that the marking elements may be attachable and/or producible at the marking points 66e, 156e by a user or by a control of the autonomous work device 10e by the user, or that the marking elements are producible and/or attachable at the marking points 66e, 156e using a device separate from the autonomous work device 10e, for example, a drilling machine.

The control unit 16e is provided so as to control the locomotion unit 14e and/or the machining unit 12e as a function of the two localization elements 74e, preferably as a function of respective positions of the two localization elements 74e, in particular for machining the object 68e, preferably at at least one machining point of the object 68e. It is contemplated that information on a target position of the at least one machining point may be stored in the machining plan, in particular in the work environment model. In particular, the machining point is different from the marking points 66e, 156e.

The two localization elements 74e define a machining line 76e. The machining line 76e is a, preferably shortest, connecting line between the two localization elements 74e. The control unit 16e is provided so as to control at least the machining unit 12e, in particular after localization of the machining unit 12e and/or the locomotion unit to a working position of the autonomous work device 10e, preferably the locomotion unit 14e and/or the machining unit 12e, to machine the object 68e, in particular to produce a drill hole in the object 68e, along the machining line 76e, in particular as a function of the two localization elements 74e. The working position of the autonomous work device 10e is a position of the autonomous work device 10e, preferably of the locomotion unit 14e, in the work environment 26e, at which in particular the object 68e to be machined is machined by the machining unit 12e, in particular by means of the localization elements 74e.

The autonomous work device 10e has at least one detection unit 30e. The detection unit 30e is provided so as to detect the at least one localization element 74e of the localization elements 74e. The detection unit 30e is designed as an optical detection unit. The detection unit 30e has a camera designed as an infrared camera 80e, in particular as a near-infrared camera, in particular for detecting the at least one localization element 74e. The control unit 16e is provided so as to control the locomotion unit 14e and/or the machining unit 12e such that the at least one localization element 74e is detected by the detection unit 30e.

It is contemplated that the control unit 16e may be provided so as to evaluate the information acquired by the camera of the detection unit 30e to localize the autonomous work device 10e, in particular the machining unit 12e and/or the locomotion unit 14e, in the work environment 26e, in particular with respect to the working position. Alternatively or additionally, it is contemplated that the camera of the detection unit may be provided so as to detect the surface characteristic or information for determining the surface characteristic in the machining area.

The autonomous work device 10e has at least one further detection unit 82e. The further detection unit 82e is provided so as to detect at least the further localization element 74e. The further detection unit 82e has an infrared camera 154e, in particular a near-infrared camera. The infrared camera 80e of the detection unit 30e is identical to the infrared camera 154e of the further detection unit 82e. The detection unit 30e and the further detection unit 82e are aligned at least substantially facing away from each other. The control unit 16e is provided so as to control the locomotion unit 14e and/or the machining unit 12e such that the at least one further localization element 74e is detected by the further detection unit 82e. The control unit 16e is provided so as to control the locomotion unit 14e and/or the machining unit 12e such that the two localization elements 74e is detected by the detection unit 30e and the further detection unit 82e, preferably simultaneously.

The machining unit 12e has a manipulator unit 72e. A tool unit 44e of the machining unit 12e is arranged on the manipulator unit 72e, in particular on a free end 118e of the manipulator unit 72e. The detection unit 30e and/or the further detection unit 82e is arranged on the manipulator unit 72e. Preferably, the machining unit 12e, in particular the manipulator unit 72e, is arranged preferably at, preferably on, the locomotion unit 14e. The tool unit 44e is provided for machining the object 68e. By way of example, the tool unit 44e is configured here to at least to produce drill holes. The tool unit 44e is at least mechanically connected to the locomotion unit 14e via the manipulator unit 72e.

The autonomous work device 10e has illumination unit 78e. The illumination unit 78e has, for example, at least one light source (not shown here), for example, an LED, a light bulb or the like. Preferably, the illumination unit 78e has a plurality of light sources (not shown here), preferably at least two light sources. The illumination unit 78e is provided so as to support the detection unit 30e, in particular the infrared camera 80e of the detection unit 30e, in detecting the at least one localization element 74e. The illumination unit 78e is provided so as to support the further detection unit 82e, in particular the infrared camera 154e of the further detection unit 82e, in detecting the further localization element 74e. The control unit 14e is provided so as to control the detection unit 30e and the illumination unit 78e to acquire an image of the localization element 74e by means of the detection unit 30e with active illumination by the illumination unit 78e and, in particular in an unchanged relative position of the autonomous work device 10e, in particular of the machining unit 12e and/or the locomotion unit 14e, to the work environment 26e, for acquiring an image of the localization element 74e by means of the detection unit 30e without active illumination by the illumination unit 78e.

The control unit 14e is provided so as to control the further detection unit 82e and the illumination unit 78e to detect an image of the further localization element 74e by means of the further detection unit 82e with active illumination by the illumination unit 78e and, in particular in an unchanged relative position of the autonomous work device 10e, in particular the machining unit 12e and/or the locomotion unit 14e, to the work environment 26e, to detect an image of the further localization element 74e by means of the further detection unit 82e without active illumination by the illumination unit 78e. When the two localization elements 74e are detected by the detection unit 30e and the further detection unit 82e, the autonomous work device 10e, in particular the machining unit 12e and/or the locomotion unit 14e, is in a fixed position relative to the work environment 26e.

The control unit 16e is provided so as to process the images acquired by the detection unit 30e with active illumination by the illumination unit 78e and free of active illumination 78e into a final image in which a background is subtracted from the localization element 74e. The control unit 16e is provided so as to process the images acquired by the further detection unit 82e with active illumination by the illumination unit 78e and free of active illumination 78e into a final image in which a background is subtracted from the further localization element 74e.

The control unit 16e is provided for aligning the machining unit 12e, in particular the manipulator unit 72e, preferably the tool unit 44e, as a function of the two localization elements 74e, in particular for machining the object 68e along the machining line 76e. The control unit 16e is provided here, for example, to control the machining unit 12e and/or the locomotion unit 14e such that the localization elements 74e detected by means of the detection unit 30e and the further detection unit 82e are arranged centrally in the respective detected, in particular finally determined, image, in particular the respective image sensor. The manipulator unit 72e, in particular the tool unit 44e, is alignable, in particular for machining the object 68e along the machining line 76e, by the control unit 16e actuating the machining unit 12e and, in particular, the locomotion unit 14e as required such that the localization elements 74e detected by the detection unit 30e and the further detection unit 82e are arranged centrally in the respective detected, in particular finally acquired, image, in particular the respective image sensor.

The images acquired by means of the detection unit 30e and/or the further detection unit 82e, in particular sensor surfaces 162e of the respective image sensors, have a rectangular landscape format here, for example. The sensor surfaces 162e of the detection unit 30e and the further detection unit 82e are shown schematically in FIG. 12, wherein in particular the detected localization elements 74e are shown in an arrangement detected centrally on the sensor surfaces 162e. Alternatively, however, it is also contemplated that the detection unit 30e and/or the further acquire unit 82e may be configured to acquire images in a square format or in a rectangular portrait format. With a central arrangement of the localization elements 74e in the respective images, in particular on the respective image sensor, a respective main extension axis of the localization elements 74e in the respective image, in particular on the respective image sensor, runs through an image center point of the respective image, in particular through a center point of the respective sensor surface 162e. With a central arrangement of the localization elements 74e in the respective images, in particular on the respective sensor surface 162e, the respective main extension axis of the localization elements 74e in the respective image, in particular on the respective sensor surface 162e, runs perpendicular to a main extension axis of the respective image, in particular perpendicular to a main extension axis of the respective sensor surface 162e, preferably with a rectangular landscape format of the images, in particular of the image sensors.

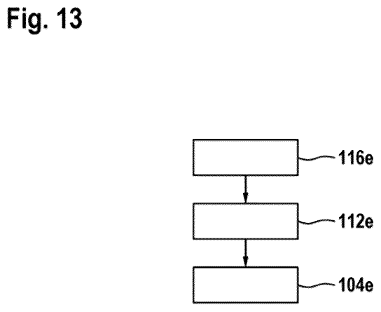

FIG. 13 shows a schematic sequence of a method for an at least partially automatic machining of the object 68d, in particular for an at least partially automatic production of drill holes in the object 68d by means of the system 36d.

In a step of the method, in particular in an installation step 116e, one of the two localization elements 74e is arranged at the two marking points 66e, 156e, preferably automatically by means of the machining unit 12e of the autonomous work device 10e.

In a step of the method, in particular in a detection step 112e, the two localization elements 74e defining the machining line 76e for the machining unit 12e are detected, in particular by means of the detection unit 30e and the further detection unit 82e.

In a step of the method, in particular in a work step 104e, the machining unit 12e and/or the locomotion unit 14e are/is controlled as a function of the localization elements 74e. In particular, the machining unit 12e is aligned by means of a control by the control unit 16e using the two localization elements 74e, preferably before the object 12e is machined by the machining unit 12e. Preferably, the machining unit 12e is aligned such that the localization elements 74e are arranged centrally on the images acquired by means of the detection unit 30e and the further detection unit 82e, in particular on the respective image sensors of the detection unit 30e and the further detection unit 82e.

The machining unit 12e and/or the locomotion unit 14e are/is controlled as a function of the localization elements 74e during machining of the object 68e, preferably during machining of the object 68e along the machining line 76e.

1. An autonomous or manual work device, comprising:
a machining unit,
a locomotion unit configured to move the machining unit,
a control unit configured to control the machining unit, and
an inclinometer and a distance measuring instrument arranged on the machining unit,
wherein the control unit is designed so as to determine a position and an orientation of at least a part of the machining unit in a work environment model as a function of measured variables determined by way of the inclinometer and the distance measuring instrument.

2. The autonomous or manual work device according to claim 1, wherein the control unit is designed so as to use at least one measured variable of the inclinometer in order to align the distance measuring instrument.

3. The autonomous or manual work device according to claim 2, wherein the distance measuring instrument is configured to detect, in a state of the distance measuring instrument aligned by way of the inclinometer, a measured variable in at least two different angular positions for determining the position and the alignment of the part of the machining unit in the work environment model.

4. The autonomous or manual work device according to claim 1, further comprising a height-adjustable work platform, which is arranged on the locomotion unit and on which the distance measuring instrument is arranged.

5. A method for an at least partially automatic machining of an object by way of an autonomous or manual work device according to claim 1, wherein a position and an orientation of at least a part of a machining unit of the work device in a work environment model are determined as a function of measured variables determined by way of an inclinometer of the work device and by way of a distance measuring instrument of the work device.

6. The method according to claim 5, wherein the distance measuring instrument is aligned by way of the inclinometer prior to capturing a measured variable.

7. The method according to claim 6, wherein the distance measuring instrument is configured to detect at least one measured variable in at least two different angular positions in a state when aligned by way of the inclinometer.

8. The method according to claim 7, wherein the distance measuring instrument is configured to rotate about an axis that runs in the vertical direction in order to capture a respective measured variable in each of at least two angular positions.

9. The autonomous or manual work device according to claim 1, wherein the autonomous or manual work device is a robot.

10. The autonomous or manual work device according to claim 1, wherein the machining unit is a drilling unit.

11. A method for an at least partially automatic production of drill holes in a part of a building by way of an autonomous or manual work device according to claim 1, wherein a position and an orientation of at least a part of a machining unit of the work device in a work environment model are determined as a function of measured variables determined by way of an inclinometer of the work device and by way of a distance measuring instrument of the work device.
